(19) United States
(12) Patent Application Publication
(10) Pub. No.: US 2017/0237274 A1
(43) Pub. Date: Aug. 17, 2017

(54) GRID CAPACITIVE POWER STORAGE SYSTEM

(71) Applicant: Capacitor Sciences Incorporated, Menlo Park, CA (US)

(72) Inventors: Pavel Ivan Lazarev, Menlo Park, CA (US); Ian S.G. Kelly-Morgan, San Francisco, CA (US); Mathew R. Robinson, San Francisco, CA (US)

(73) Assignee: Capacitor Sciences Incorporated, Menlo Park, CA (US)

(21) Appl. No.: 15/430,339

(22) Filed: Feb. 10, 2017

Related U.S. Application Data
(63) Continuation-in-part of application No. 15/043,186, filed on Feb. 12, 2016.
Application No. 15/043,186 is a continuation-in-part of application No. 15/043,209, filed on Feb. 12, 2016.
Application No. 15/043,209 is a continuation-in-part of application No. 15/043,247, filed on Feb. 12, 2016.
Application No. 15/043,247 is a continuation-in-part of application No. 15/043,315, filed on Feb. 12, 2016.
(60) Provisional application No. 62/294,964, filed on Feb. 12, 2016.

(51) Int. Cl. H02J 7/00; H02M 7/68; H02J 7/34

(52) U.S. Cl. CPC H02J 7/0045; H02J 7/0026; H02J 7/007; H02J 7/345; H02M 7/68

(57) ABSTRACT

A capacitor based energy storage system (CBESS) and methods of using it are disclosed. The CBESS uses meta-capacitors in its capacitive energy storage devices (CESD) to configure capacitive energy storage cells (CESC), which are used to configure capacitive energy storage modules (CESM) to achieve the CBESS's function as an uninterruptible power supply. The CBESS is connected to a power generation system (PGS), a load, and a power grid. When the grid is in an abnormal state, the CESM is simultaneously charged with power from the PGS and used to supply power to the load. If a remaining amount of power of a CESM is less than a predetermined level, the CESM is charged with power from PGS or grid. The CBESS interfaces with a computer system or network to buy or sell electricity to the grid depending on grid electricity cost and CESD charging states.

### CROSS-REFERENCE TO RELATED APPLICATIONS

This application claims the priority benefit of U.S. Provisional Patent Application, No. 62/294,964, filed on 12 Feb. 2016, in the USPTO, the entire disclosures of which are incorporated herein by reference. This application is a continuation-in-part of U.S. patent applications Ser. Nos. 15/043,315, 15/043,186, 15/043,209, and 15/043,247, all of which were filed Feb. 12, 2016, the entire contents of all of which are incorporated herein by reference.

### BACKGROUND OF THE DISCLOSURE

1. Field of the Invention

This present disclosure relates to a power storage system for supplying power to a load or a power grid in association with a power generation system and a power grid. Additionally, this invention relates to a method of operating a power storage system to supply power to a load or a power grid in association with a power generation system and a power grid. Unlike conventional power storage systems that are based on batteries, the power storage system in this invention is based on capacitors.

2. Description of the Related Art

Power storage systems use diverse methods to store energy for use at a later time when demand for electricity peaks or increases rapidly, and the power storage industry has continued to evolve and adapt to changes in energy requirements and advances in technology.

Power storage systems are commonly associated with a power grid, i.e., electricity grid, but there are independent power storage systems that are not associated with a power grid. In most cases, electrical power is not generated at the same location as it is consumed. The power grid transmits power generated at various facilities, e.g., power plants, and distributes the power to consumers, i.e., end users, often over long distances. Additionally, the power grid includes transmission lines, which are necessary to carry high-voltage electricity over long distances and to connect electricity generators with electricity consumers, and distribution networks, which are simply the system of wires that picks up where the transmission lines leave off. The power grid provides electricity not only to residential, commercial, and governmental buildings, but also to commercial and industrial facilities, year-round and every minute of every day. Power generation systems generate power that is transmitted to a power grid, and if the power generation system does not generate sufficient amount of power, the deficient power is supplied from the power grid. Independent power storage systems store power generated by power generation systems or by a power grid and use that stored power if needed. It is necessary to develop various power storage systems to manage our energy supply, so we can create a more resilient energy infrastructure and bring cost savings to utilities and consumers.

The reliability of adequate power for distribution to end users depends on both the availability of power generated and the proper flow of electricity through the power grid. A breakdown of a power generator, a transmission line, or a distribution network can cause a complete or partial power disruption in the normal flow of electricity to the power grid. In addition, there may be a transition period, sometimes called a quasi-normal state, that occurs between power disruption, i.e., abnormal state, and normal state of power distribution. In instances of disruption and transition, an energy storage system (ESS) back up for the load, e.g., a residential building with modern electric power usage, on the consumer side may be used to maintain reliable electricity to the end user. In this situation, the ESS performs an uninterruptible power supply (UPS) function and transfers the stored power to the load.

Moon—U.S. Pat. No. 8,575,780 B2—describes a prior art attempt at such an energy storage system which uses a battery including a plurality of battery units. The energy storage system, which is called a power storage apparatus in Moon, is connected to a power generation system, a power grid, and a load. The apparatus uses an integrated controller to determine a state of the power grid. If the grid is in an abnormal state, the integrated controller monitors the charging and discharging status of each battery units. The battery units that are in a completely charged state are discharged to supply power to the load, and the battery units that are in an incomplete charging state are charged with power from the power generation system. According to Moon, the battery may be a nickel-cadmium (Ni-Cad) battery, a lead acid battery, a nickel metal hydride battery (NiMH), a lithium ion battery, a lithium polymer battery, et cetera.

However, the use of rechargeable batteries, such as in Moon, has major drawbacks. For example, a NiMH battery has a very high self-discharge rate of approximately 5 to 10% per day. This would make the battery useless in a few weeks. The Ni-Cad battery, like the lead-acid battery, is also subject to self-discharge, but the discharge rate is in the range of about 1% per day; both contain hazardous materials such as acid or highly toxic cadmium. The NiMH batteries contain the potassium hydroxide electrolyte. This electrolyte, in moderate and high concentrations, is very caustic. It will cause severe burns to tissue and corrosion to many metals. Furthermore, lead-acid batteries require a very long recharge period, as long as 6 to 8 hours. Because of their chemical makeup, lead acid batteries cannot sustain high current or voltage continuously during charging. The lead plates within the battery heat rapidly and cool very slowly. Too much heat results in a condition known as “gassing” where hydrogen and oxygen gases are released from the battery's vent cap. Over time, gassing reduces the efficacy of the battery and increases the need for battery maintenance. Ni-Cad and NiMH batteries are not as susceptible to heat, and they can be recharged in less time than lead-acid batteries. The time to fully recharge these batteries can be longer than an hour. Moreover, a common drawback to rechargeable batteries is a finite life, and if they are fully discharged and recharged on a regular basis, their life is reduced significantly. Additionally, rechargeable batteries have drawbacks due to relatively large weight per unit energy stored, limited power availability per unit weight, limited power availability per unit energy, and degradation of storage capacity as the number of charge-discharge cycles increases.

An improved energy storage system is needed, one that—among other improvements compared to the prior art—addresses the drawbacks of using rechargeable batteries, such as in Moon.

### SUMMARY OF THE DISCLOSURE

Aspects of the present disclosure address the drawbacks with conventional energy storage systems. The present disclosure describes a capacitor based energy storage system (CBESS). Such a system includes a capacitive energy storage system (CESS) including a plurality of capacitive energy storage modules (CESM) and an integrated system controller coupled to the plurality of CESM. Each CESM includes a plurality of capacitive energy storage cells (CESC) configured to be charged with power from a power generation system or a power grid and to be discharged to supply power to a load or the power grid. Each CESC includes at least one capacitive energy storage device (CESD) coupled to a DC-voltage conversion device having one or more switch-mode voltage converters coupled to the terminals of the CESD. Each CESC includes a control board to stabilize an output voltage of the DC-voltage conversion device and to control charging and discharging of each CESD. Each CESD includes at least one meta-capacitor, which is described below. An output voltage of the CESD is an input voltage of the DC-voltage conversion during discharging the CESD, and an input voltage of the CESD is the output voltage of the DC-voltage conversion device while charging the CESD. Aspects and interconnections of the CESS, CESM, CESC, CESD, DC-voltage conversion device, switch-mode voltage converters, and meta-capacitor are set forth in pages 2 to 11, in pages 16 to 24, and in FIGS. 1 to 17, of a U.S. patent application (Ser. No. 15/043,315) to Ian Kelly Morgan, filed on 12 Feb. 2016, in which the entire disclosure is incorporated herein by reference.

Furthermore, the CBESS comprises a power connection system that is coupled to the aforementioned CESS. The power connection system includes a power conversion unit (PCU), a bi-directional inverter, an optional DC link capacitor, and a grid connector. The PCU is connected between the power generation system (PGS) and a first node, and is configured to convert power that the PGS generated into a DC voltage for the first node. The bi-directional inverter is connected between the first node and a second node, and is configured to convert the DC voltage for the first node into an AC voltage for the load or the power grid. Moreover, the bi-directional inverter is configured to convert an AC voltage from the power grid into the DC voltage for the first node. The optional DC link capacitor is connected to the first node, and the grid connector is connected between the power grid and the second node.

Additionally, in the aforesaid CBESS, the integrated system controller is linked to the PCU, the bi-directional inverter, and the grid connector. The integrated system controller is configured to determine a state of the power grid. In one implementation, if the power grid is in an abnormal state, the integrated system controller monitors a charging status and a discharging status of each CESD, controls each CESD to supply power to the load, and charges one or more CESD or simultaneously charges all CESD with power generated by the PGS. In another implementation, if the power grid is in the abnormal state, the integrated system controller supplies the load with power generated by the PGS. In yet another implementation, if the power grid is in the abnormal state, the at least one CESD that is charged below a minimum level, as determined by the control board or the integrated system controller, can be charged with power supplied from the PGS, and the at least one CESD that is charged above a minimum level, as determined by the control board or the integrated system controller, can be discharged by supplying power to the load.

Additionally, in one implementation of the CBESS, among others, the integrated system controller comprises an integrated controller and a system controller. The integrated controller may include the following: (1) a grid connector controller that is configured to detect the abnormal state of the power grid, to control the grid connector, and to disconnect the power grid from the second node; (2) a CESM Monitoring Unit that is configured to monitor the charging and discharging states of the plurality of CESC; (3) a Switching Controller that controls the switching elements connected to each CESC for charging or discharging; (4) a charging controller that the DC-voltage conversion device and the system controller enable to regulate the charging of the plurality of CESC; and (5) a discharging controller that the DC-voltage conversion device and the system controller enable to regulate the discharging of the plurality of CESC. The system controller includes the following: (1) a switching control logic circuitry configured to control the operation of not only a plurality of system power switches (SPSW) within the CESS, but also a plurality of power switches (PSW) within an individual CESM; (2) a voltage control logic circuitry configured to send voltage control signals to a specific DC-voltage conversion device within a specific cell (CESC) of a specific module (CESM); and (3) a system network interface coupled to the switching control logic, the voltage control logic, a system data bus, a system power meter, and the plurality of SPSW.

In another implementation of the CBESS, among others, the CBESS interfaces with a computer network or a computer system. The computer network or the computer system is operable to determine a cost of electricity from the power grid and a cost of electricity from the power generation system. The CESS is operable to charge the at least one CESD and to supply electricity to the load, with power from the power generation system, if the cost of electricity from the power generation system is less than the cost of electricity from the power grid or from a predetermined price. Additionally, the CESS is operable to sell electricity to the power grid by discharging the at least one CESD if the cost of electricity from the PGS is less than the cost of electricity from the power grid. Furthermore, the CESS is operable to buy electricity from the power grid to charge the at least one CESD if the cost of electricity from the power grid is less than a predetermined price.

Moreover, an aspect of the present disclosure is a method of operating a CBESS connected to a PGS, a power grid, and a load. The CBESS comprises not only a capacitive energy storage system (CESS) containing a plurality of capacitive energy storage modules (CESM) coupled to an integrated system controller but also a power connection system coupled to the CESM and the integrated system controller. Each CESM includes a plurality of capacitive energy storage cells (CESC) configured to be charged with power from the PGS or the power grid and to be discharged to supply power to the load or the power grid. Each CESC includes at least one capacitive energy storage device (CESD) coupled to a DC-voltage conversion device. The at least one CESD includes at least one meta-capacitor. The power connection system contains a PCU, a bidirectional inverter, an optional DC link capacitor, and a grid connector. The PCU is connected between the PGS and a first node and configured to convert power generated by the PGS into a DC voltage for the first node. The bidirectional inverter is connected between the first node and a second node and configured to convert the DC voltage for the first node into an AC voltage for the load or the power grid and to convert an AC voltage from the power grid into the DC voltage for the first node. The optional DC link capacitor is connected to the first node, and the grid connector is connected between the power grid and the second node. The method may include: (1) disconnecting the power grid from the CBESS as a result of the power grid being in an abnormal state; (2) monitoring a charging status and a discharging status of each of the CESD; and (3) according to the charging status and the discharging status of each of the CESD, discharging the at least one CESD to supply power to the load and simultaneously charging the at least one CESD with power generated by the PGS.

In another implementation of the aforementioned method, in which the CBESS interfaces with a computer network or a computer system, the method may include: (1) using the computer network or the computer system to determine a cost of electricity from the power grid and a cost of electricity from the PGS; (2) using the CESS to charge the at least one CESD and to supply electricity to the load, with power from the PGS, if the cost of electricity from the PGS is less than the cost of electricity from the power grid or from a predetermined price; (3) selling electricity to the power grid by discharging the at least one CESD if the cost of electricity from the PGS is less than the cost of electricity from the power grid or from a predetermined price; and (4) buying electricity from the power grid to charge the at least one CESD if the cost of electricity from the power grid is less than a predetermined price.

One major novel aspect of the present invention is the use of at least one meta-capacitor. A meta-capacitor is a dielectric film capacitor whose dielectric film is a meta-dielectric material layer, which is disposed between a first electrode and a second electrode. A meta-dielectric material is described below. Meta-capacitors have greater energy storage capacity than conventional ultracapacitors or supercapacitors. Unlike rechargeable batteries, capacitors, including meta-capacitors, can be charged relatively quickly, can be deeply discharged without suffering damage, and can undergo large numbers of charge and discharge cycles without damage.

A meta-dielectric material is defined here as a dielectric material comprised of one or more types of structured polymeric materials (SPMs) having a relative permittivity greater than or equal to 1000 and resistivity greater than or equal to 10¹³ Ohm·cm. Individually, the SPMs in a meta-dielectric may form column like supramolecular structures by pi-pi interaction or hydrophilic and hydrophobic interactions. Said supramolecules of SPMs may permit formation of crystal structures of the meta-dielectric material. By way of using SPMs in a dielectric material, polarization units are incorporated to provide the molecular material with high dielectric permeability. There are several mechanisms of polarization such as dipole polarization, ionic polarization, and hyper-electronic polarization of molecules, monomers and polymers possessing metal conductivity. All polarization units with the listed types of polarization may be used in aspects of the present disclosure. Further, SPMs are composite materials which incorporate an envelope of insulating substituent groups that electrically isolate the supramolecules from each other in the dielectric layer and provide high breakdown voltage of the energy storage molecular material. The insulating substituent groups are hydrocarbon (saturated and/or unsaturated), fluorocarbon, siloxane, and/or polyethylene glycol linear or branched chains covalently bonded to a polarizable core or co-polymer backbone, forming the resistive envelope.

A meta-dielectric material layer has multiple aspects. In one aspect, a metadielectric material layer is comprised of structured polymeric materials (SPM) having a relative permittivity greater than or equal to 1000, a resistivity greater than or equal to 10¹⁵ Ohm·cm, and a breakdown field greater than or equal to 0.01 volts/nm. In another aspect, a meta-dielectric material layer is comprised of one or more composite organic compounds characterized by polarizability and resistivity. In yet another aspect, a meta-dielectric material layer is comprised of composite organic compounds forming supra-structures. In an aspect, a metadielectric material layer is comprised of composite organic compounds forming supra-structures that are crystalline in at least 1 dimension. Lastly, in an aspect, a metadielectric material layer is comprised of polymeric chains tethered polarization substituents and electrically resistive side chains that enable structured polymer films. The meta-dielectric material layer in this invention may have one or more of the aforementioned aspects.

Furthermore, the meta-dielectric material layer maybe a composite organic compound, an organic polymeric compound, an organic co-polymeric compound, or any combination of these compounds. A composite organic compound is herein referred to as a “Sharp polymer.” A Sharp polymer may have a core that is an aromatic polycyclic conjugated molecule, and the molecule may have flat anisometric form and self-assembles by pi-pi stacking in a column-like supramolecule. An organic polymeric compound is herein referred to as “para-Furuta polymer.” And an organic co-polymeric compound is herein referred to as “Furuta co-polymer.” Para-Furuta polymers and Furuta co-polymers are referred to collectively as Furuta polymers. Sharp polymers, Furuta co-polymers, and para-Furuta polymers are described in detail in commonly-assigned U.S. patent applications, i.e., (1) application Ser. No. 15/043,247 (Attorney Docket No. CSI-046); application Ser. No. 15/043,186 (Attorney Docket No. CSI-019A); and application Ser. No. 15/043,209 (Attorney Docket No. CSI-019B). These three applications are all filed on 12 Feb. 2016, and the disclosures of these applications are incorporated herein in their entirety by reference.

A meta-capacitor has multiple possible implementations. For example, in one implementations, the electrodes are flat, planar, and positioned parallel to each other. In another embodiment, the first electrode, second electrode, and meta-dielectric material layer are in a form of long strips of material that are sandwiched together and wound into a coil along with an insulating material to prevent electrical shorting between the first electrode and the second electrode. In yet another implementation, the meta-capacitor comprises two rolled metal electrodes positioned parallel to each other. Furthermore, in an embodiment, the meta-capacitor's electrodes may be planar and parallel, but not necessarily flat; they may be coiled, rolled, bent, folded, or otherwise shaped to reduce the overall form factor of the meta-capacitor. In another embodiment, the meta-capacitor's electrodes may be non-flat, non-planar, or non-parallel, or some combination of two or more of these. The foregoing embodiments are intended to illustrate but not to limit the possible embodiments of the meta-capacitor.

The features and advantages described in the specification are not all inclusive. Particularly, many additional features and advantages will be evident to one of ordinary skill in the art in view of the specification and drawings. Furthermore, please note that the specification had been written for readability and instructional purposes, and it was not written to delineate, circumscribe, or confine the inventive subject matter of the invention.

### BRIEF DESCRIPTION OF THE SEVERAL VIEWS OF THE DRAWINGS

In the accompanying drawings, like numerals depict like elements. Together with not only the preceding brief summary of the invention but also the detailed description that follows, the drawings illustrate embodiments of the present disclosure and serve to explain, but not to limit, the principles of the disclosure.

FIG. 1 is a cross-sectional diagram depicting a meta-capacitor according to an aspect of the present disclosure.

FIG. 2 is a block diagram illustrating elements of a capacitive energy storage device (CESD) in an embodiment according to an aspect of the present disclosure.

FIG. 3A is a schematic diagram illustrating elements of a switch-mode voltage converter implementing a standard boost circuit, in an embodiment according to an aspect of the present disclosure

FIG. 3B is a schematic diagram illustrating elements of a switch-mode voltage converter implementing a standard buck circuit, in an embodiment according to an aspect of the present disclosure.

FIG. 4 is a schematic diagram illustrating elements of a DC-voltage conversion device in an embodiment according to an aspect of the present disclosure.

FIG. 5 is a schematic diagram illustrating elements of a capacitive energy storage cell (CESC) in an embodiment according to an aspect of the present disclosure.

FIG. 6 is a schematic diagram illustrating elements of a capacitive energy storage module (CESM) in an embodiment according to an aspect of the present disclosure.

FIG. 7 is a diagram illustrating elements of a capacitive energy storage system (CESS) in an embodiment according to an aspect of the present disclosure.

FIG. 8 is a block diagram illustrating elements of an integrated system controller according to an aspect of the present disclosure.

FIG. 9 is a block diagram illustrating elements of a capacitor based energy storage system in an embodiment according to an aspect of the present invention.

FIG. 10 is a state diagram illustrating an operation of a capacitor based energy storage system in an embodiment according to an aspect the present disclosure.

FIG. 11 is a flowchart illustrating a method of operating a capacitor based energy storage system in an embodiment according to an aspect of the present disclosure.

### DETAILED DESCRIPTION

Certain embodiments will now be described. Examples of specific implementations of those embodiments are illustrated in the accompanying drawings, in which like reference numerals generally refer to like elements throughout. The embodiments may have different forms, and they should not be construed as limited to the specific descriptions set forth herein. Accordingly, the exemplary embodiments are described below, with reference to the figures, to explain, but not to limit, certain inventive aspects of the present description.

Furthermore, in the following detailed description of the present disclosure, numerous specific details are set forth in order to provide a thorough understanding of the present disclosure. However, the present disclosure may be practiced without these specific details. In other instances, well-known methods, procedures, components, and circuits have not been described in detail to avoid unnecessarily obscuring aspects of the present disclosure.

All the features disclosed in this specification—including any accompanying claims, abstract, and drawings—may be replaced by alternative features serving the same, equivalent, or similar purpose, unless expressly stated otherwise. Thus, unless expressly stated otherwise, each feature disclosed is one example only of a generic series of equivalent or similar features.

Some of the terms as used herein are for descriptive purposes only. For example, the terms “first”, “second”, or the like may be used to describe different elements, but the elements are not limited by those terms. The terms may be used to distinguish one element from other elements. In some instances, singular forms may include plural forms as well, unless defined otherwise. The terms “include”, “have”, “comprise”, “consist”, or the like are used to designate existence of, for example, a characteristic, a number, a step, an operation, an element, a part, or a combination thereof. These terms are not to be understood to exclude existence or addition of one or more other characteristics, numbers, steps, operations, elements, parts, or combinations thereof.

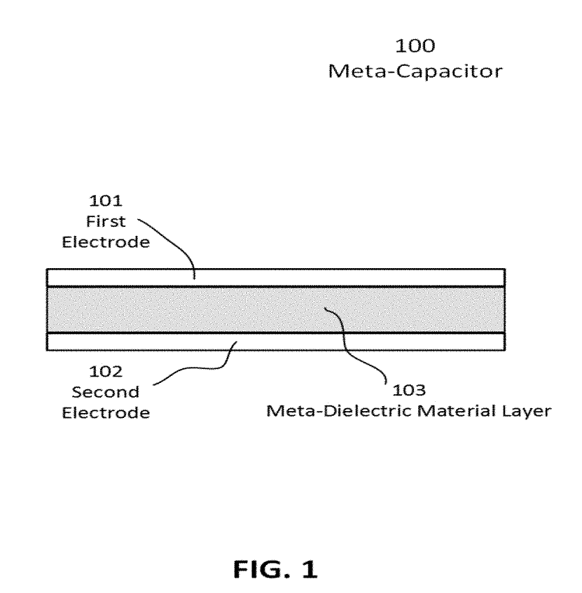

FIG. 1 is a diagram of a meta-capacitor in an embodiment according to aspects of the present disclosure. As briefly discussed above, a meta-capacitor is a dielectric film capacitor whose dielectric film is a meta-dielectric material layer, which is disposed between a first electrode and a second electrode. In FIG. 1, First Electrode 101 and Second Electrode 102 may be flat, planar, and positioned parallel to each other. Alternatively, first Electrode 101 and Second Electrode 102 may be planar and parallel but not necessarily flat. For example, the electrodes may be coiled, rolled, bent, folded, or otherwise shaped to reduce the overall form factor of the capacitor. It is possible for the electrodes to be non-flat, non-planar, or non-parallel or some combination of two or more of these.

Furthermore, as briefly discussed above, a meta-dielectric material layer is comprised of, for example a Sharp polymer, a Furuta Polymer, a para-Furuta polymer, or any combination of these three polymers. These three polymers are discussed fairly thoroughly in paragraphs [0041] to [0053], which follow.

Sharp polymers are composites of a polarizable core inside an envelope of hydrocarbon (saturated and/or unsaturated), fluorocarbon, chlorocarbon, siloxane, and/or polyethylene glycol as linear or branched chain oligomers covalently bonded to the polarizable core that act to insulate the polarizable cores from each other, which favorably allows discrete polarization of the cores with limited or no dissipation of the polarization moments in the cores. The polarizable core has hyperelectronic or ionic type polarizability. “Hyperelectronic polarization may be considered due to the pliant interaction of charge pairs of excitons, localized temporarily on long, highly polarizable molecules, with an external electric field[,] Roger D. Hartman and Herbert A. Pohl, “Hyper-electronic Polarization in Macromolecular Solids,” Journal of Polymer Science: Part A-1 Vol. 6, pp. 1135-1152 (1968)).” Ionic type polarization can be achieved by limited mobility of ionic parts of the core molecular fragment.

A Sharp polymer has the following general structural formula:

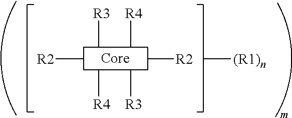

From the above general structural formula, Core is an aromatic polycyclic conjugated molecule comprising rylene fragments. This molecule has flat anisometric form and self-assembles by pi-pi stacking in a column-like supramolecule. The substitute R1 provides solubility of the organic compound in a solvent. The parameter “n” is number of substitutes R1, which is equal to 0, 1, 2, 3, 4, 5, 6, 7 or 8. The substitute R2 is an electrically resistive substitute located in terminal positions, which provides resistivity to electric current and comprises hydrocarbon (saturated and/or unsaturated), fluorocarbon, siloxane, and/or polyethyleneglycol as linear or branched chains. The substitutes R3 and R4 are substitutes located on side (lateral) positions (terminal and/or bay positions) comprising one or more ionic groups from a class of ionic compounds that are used in ionic liquids connected to the aromatic polycyclic conjugated molecule (Core), either directly, e.g., with direct bound SP2-SP3 carbons, or via a connecting group. The parameter “m” is a number of the aromatic polycyclic conjugated molecules in the column-like supramolecule, which is in a range from 3 to 100,000.

In another embodiment of the composite organic compound, the aromatic polycyclic conjugated molecule comprises an electro-conductive oligomer, such as a phenylene, thiophene, or polyacene quinine radical oligomer or combinations of two or more of these. In yet another embodiment of the composite organic compound, the electro-conductive oligomer is selected from phenylene, thiophene, or substituted and/or unsubstituted polyacene quinine radical oligomer of lengths ranging from 2 to 12 repeat units of the monomer forming the listed oligomer types or combination of two or more of these. The substitutions of ring hydrogens by O, S or NRS, and R5 is selected from the group consisting of unsubstituted or substituted C₁-C₁₈ alkyl, unsubstituted or substituted C₂-C₁₈ alkenyl, unsubstituted or substituted C₂-C₁₈ alkynyl, and unsubstituted or substituted C₄-C₁₈ aryl.

In some embodiments, the substitute providing solubility (R1) of the composite organic compound is C_{X}Q_{2X+1}, where X≧1 and Q is hydrogen (H), fluorine (F), or chlorine (Cl). In still another embodiment of the composite organic compound, the substitute providing solubility (R1) of the composite organic compound is independently selected from alkyl, aryl, substituted alkyl, substituted aryl, fluorinated alkyl, chlorinated alkyl, branched and complex alkyl, branched and complex fluorinated alkyl, branched and complex chlorinated alkyl groups, and any combination thereof, and wherein the alkyl group is selected from methyl, ethyl, propyl, butyl, iso-butyl and tert-butyl groups, and the aryl group is selected from phenyl, benzyl and naphthyl groups or siloxane, and/or polyethylene glycol as linear or branched chains.

In some embodiments, at least one electrically resistive substitute (R2) of the composite organic compound is C_{X}Q_{2X+1}, where X≧1 and Q is hydrogen (H), fluorine (F), or chlorine (Cl). In another embodiment of the composite organic compound, at least one electrically resistive substitute (R2) is selected from the list comprising —(CH₂)ₙ—CH₃, —CH((CH—₂)ₙCH₃)₂) (where n≧1), alkyl, aryl, substituted alkyl, substituted aryl, branched alkyl, branched aryl, and any combination thereof and wherein the alkyl group is selected from methyl, ethyl, propyl, butyl, iso-butyl and tert-butyl groups, and the aryl group is selected from phenyl, benzyl and naphthyl groups.

In some embodiments, the substitute R1 and/or R2 is connected to the aromatic polycyclic conjugated molecule (Core) via at least one connecting group. The at least one connecting group may be selected from the list comprising the following structures: ether, amine, ester, amide, substituted amide, alkenyl, alkynyl, sulfonyl, sulfonate, sulfonamide, or substituted sulfonamide.

In some embodiments, the substitute R3 and/or R4 may be connected to the aromatic polycyclic conjugated molecule (Core) via at least one connecting group. The at least one connecting group may be selected from the list comprising CH₂, CF₂, SiR₂O, CH₂CH₂O, wherein R is selected from the list comprising H, alkyl, and fluorine. In another embodiment of the composite organic compound, the one or more ionic groups include at least one ionic group selected from the list comprising [NR₄]⁺, [PR₄]⁺ as cation and [—CO₂]⁻, [—SO₃]⁻, [—SR₅]⁻, [—PO₃R]⁻, [—PR₅]⁻ as anion, wherein R is selected from the list comprising H, alkyl, and fluorine.

The present disclosure provides a Sharp polymer in the form of a composite organic compound. In one embodiment of the composite organic compound, the aromatic polycyclic conjugated molecule (Core) comprises rylene fragments. In another embodiment of the composite organic compound, the rylene fragments are selected from structures 1 to 21 as given in Table 1.

TABLE 1
Examples of the polycyclic organic molecule (Core) comprising rylene
fragments

| | |
|---|---|
| 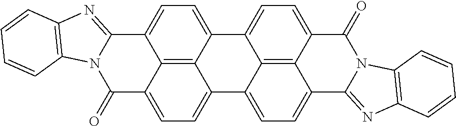 [SMILES: O=c1c2ccc3c4ccc5c6c(ccc(c7ccc(c2c37)c2nc3ccccc3n12)c46)c(=O)n1c2ccccc2nc51] | 1 |
| 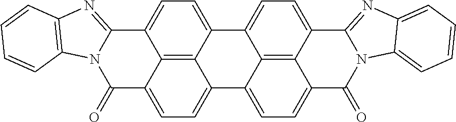 [SMILES: O=c1c2ccc3c4ccc5c(=O)n6c7ccccc7nc6c6ccc(c7ccc(c2c37)c2nc3ccccc3n12)c4c56] | 2 |
| 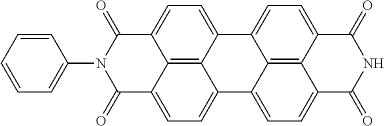 [SMILES: O=C1NC(=O)c2ccc3c4ccc5c6c(ccc(c7ccc1c2c73)c64)C(=O)N(c1ccccc1)C5=O] | 3 |
| 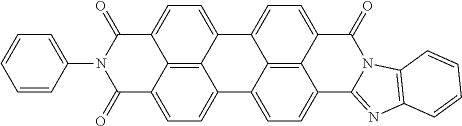 [SMILES: O=C1c2ccc3c4ccc5c(=O)n6c7ccccc7nc6c6ccc(c7ccc(c2c37)C(=O)N1c1ccccc1)c4c56] | 4 |
| 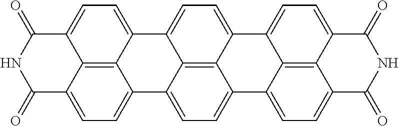 [SMILES: O=C1NC(=O)c2ccc3c4ccc5c6ccc7c8c(ccc(c9ccc(c%10ccc1c2c%103)c4c95)c86)C(=O)NC7=O] | 5 |
| 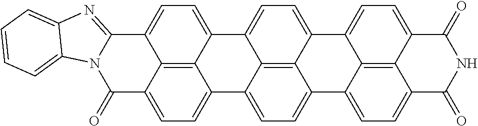 [SMILES: O=C1NC(=O)c2ccc3c4ccc5c6ccc7c8c(ccc(c9ccc(c%10ccc1c2c%103)c4c95)c68)c(=O)n1c2ccccc2nc71] | 6 |
| 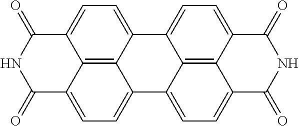 [SMILES: O=C1NC(=O)c2ccc3c4ccc5c6c(ccc(c7ccc1c2c73)c64)C(=O)NC5=O] | 7 |
| 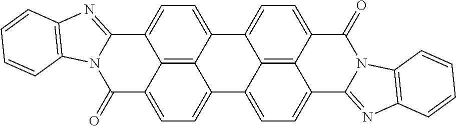 [SMILES: O=c1c2ccc3c4ccc5c6c(ccc(c7ccc(c2c37)c2nc3ccccc3n12)c46)c(=O)n1c2ccccc2nc51] | 8 |
| 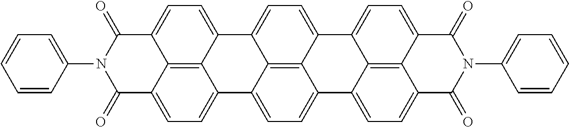 [SMILES: O=C1c2ccc3c4ccc5c6ccc7c8c(ccc(c9ccc(c%10ccc(c2c3%10)C(=O)N1c1ccccc1)c4c59)c86)C(=O)N(c1ccccc1)C7=O] | 9 |
| 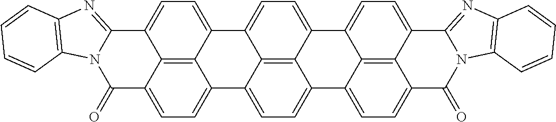 [SMILES: O=c1c2ccc3c4ccc5c6ccc7c(=O)n8c9ccccc9nc8c8ccc(c9ccc(c%10ccc(c2c3%10)c2nc3ccccc3n12)c4c59)c6c78] | 10 |
| 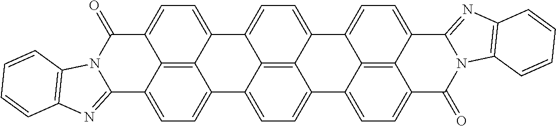 [SMILES: O=c1c2ccc3c4ccc5c6ccc7c8c(ccc(c9ccc(c%10ccc(c2c3%10)c2nc3ccccc3n12)c4c95)c68)c(=O)n1c2ccccc2nc71] | 11 |
| 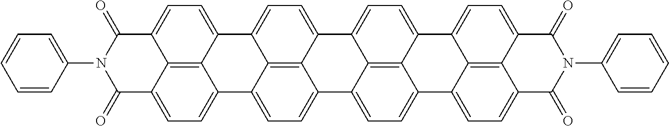 [SMILES: O=C1c2ccc3c4ccc5c6ccc7c8ccc9c%10c(ccc(c%11ccc(c%12ccc(c%13ccc(c2c3%13)C(=O)N1c1ccccc1)c4c5%12)c6c7%11)c%108)C(=O)N(c1ccccc1)C9=O] | 12 |
| 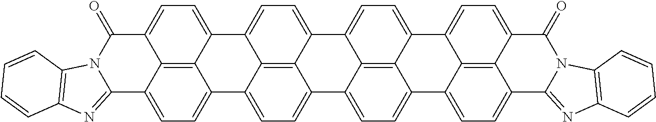 [SMILES: O=c1c2ccc3c4ccc5c6ccc7c8ccc9c(=O)n%10c%11ccccc%11nc%10c%10ccc(c%11ccc(c%12ccc(c%13ccc(c2c3%13)c2nc3ccccc3n12)c4c5%12)c6c7%11)c8c9%10] | 13 |
| 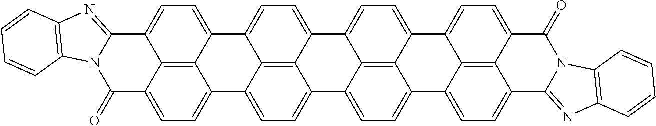 [SMILES: O=c1c2ccc3c4ccc5c6ccc7c8ccc9c%10c(ccc(c%11ccc(c%12ccc(c%13ccc(c2c3%13)c2nc3ccccc3n12)c4c5%12)c6c%117)c8%10)c(=O)n1c2ccccc2nc91] | 14 |
| 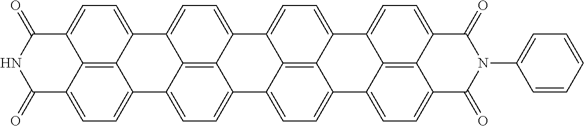 [SMILES: O=C1NC(=O)c2ccc3c4ccc5c6ccc7c8ccc9c%10c(ccc(c%11ccc(c%12ccc(c%13ccc1c2c%133)c4c%125)c6c%117)c%108)C(=O)N(c1ccccc1)C9=O] | 15 |
| 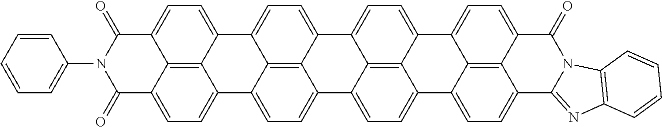 [SMILES: O=C1c2ccc3c4ccc5c6ccc7c8ccc9c(=O)n%10c%11ccccc%11nc%10c%10ccc(c%11ccc(c%12ccc(c%13ccc(c2c3%13)C(=O)N1c1ccccc1)c4c5%12)c6c7%11)c8c9%10] | 16 |
| 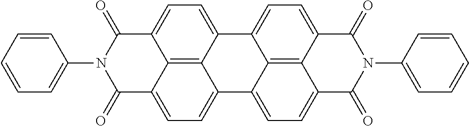 [SMILES: O=C1c2ccc3c4ccc5c6c(ccc(c7ccc(c2c37)C(=O)N1c1ccccc1)c64)C(=O)N(c1ccccc1)C5=O] | 17 |
| 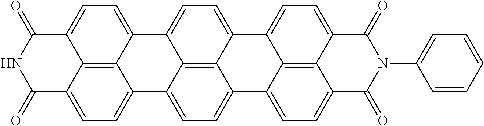 [SMILES: O=C1NC(=O)c2ccc3c4ccc5c6ccc7c8c(ccc(c9ccc(c%10ccc1c2c%103)c4c95)c86)C(=O)N(c1ccccc1)C7=O] | 18 |
| 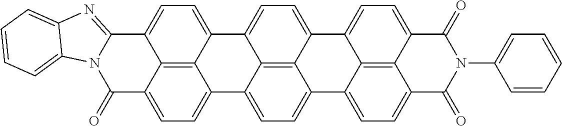 [SMILES: O=C1c2ccc3c4ccc5c6ccc7c(=O)n8c9ccccc9nc8c8ccc(c9ccc(c%10ccc(c2c3%10)C(=O)N1c1ccccc1)c4c59)c6c78] | 19 |
| 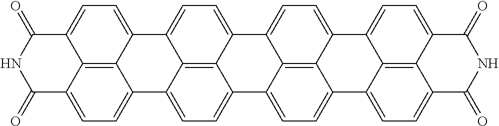 [SMILES: O=C1NC(=O)c2ccc3c4ccc5c6ccc7c8ccc9c%10c(ccc(c%11ccc(c%12ccc(c%13ccc1c2c%133)c4c%125)c6c%117)c%108)C(=O)NC9=O] | 20 |
| 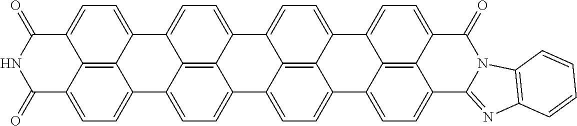 [SMILES: O=C1NC(=O)c2ccc3c4ccc5c6ccc7c8ccc9c%10c(ccc(c%11ccc(c%12ccc(c%13ccc1c2c%133)c4c%125)c6c%117)c8%10)c(=O)n1c2ccccc2nc91] | 21 |

In another embodiment of the composite organic compound, the aromatic polycyclic conjugated molecule comprises an electro-conductive oligomer, such as a phenylene, thiophene, or polyacene quinine radical oligomer or combinations of two or more of these. In yet another embodiment of the composite organic compound, the electro-conductive oligomer is selected from structures 22 to 30 as given in Table 2, wherein I=2, 3, 4, 5, 6, 7, 8, 9, 10, 11 or 12, Z is ═O, ═S or ═NR5, and R5 is selected from the group consisting of unsubstituted or substituted C₁-C₁₈alkyl, unsubstituted or substituted C₂-C₁₈alkenyl, unsubstituted or substituted C₂-C₁₈alkynyl, and unsubstituted or substituted C₄-C₁₈aryl:

TABLE 2
Examples of the polycyclic organic molecule (Core) comprising electro-
conductive oligomer

| | |
|---|---|
| 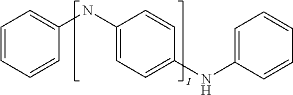 | 22 |
| 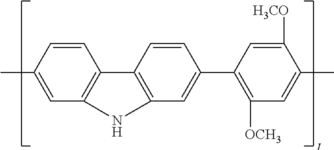 | 23 |
| 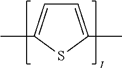 | 24 |
| 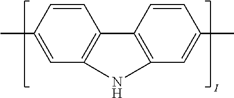 | 25 |
| 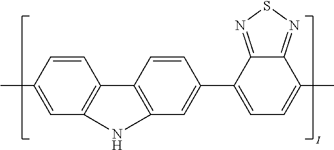 | 26 |
| 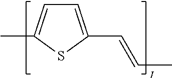 | 27 |
| 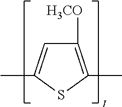 | 28 |
| 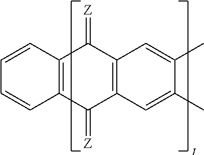 | 29 |
| 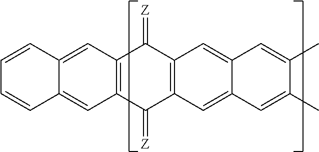 | 30 |

In some embodiments, the substitute providing solubility (R1) of the composite organic compound is C_{X}Q_{2X+1}, where X≧1 and Q is hydrogen (H), fluorine (F), or chlorine (Cl). In still another embodiment of the composite organic compound, the substitute providing solubility (R1) of the composite organic compound is independently selected from alkyl, aryl, substituted alkyl, substituted aryl, fluorinated alkyl, chlorinated alkyl, branched and complex alkyl, branched and complex fluorinated alkyl, branched and complex chlorinated alkyl groups, and any combination thereof, and wherein the alkyl group is selected from methyl, ethyl, propyl, butyl, iso-butyl and tent-butyl groups, and the aryl group is selected from phenyl, benzyl and naphthyl groups or siloxane, and/or polyethyleneglycol as linear or branched chains.

In one embodiment of the composite organic compound, the solvent is selected from benzene, toluene, xylenes, acetone, acetic acid, methylethylketone, hydrocarbons, chloroform, carbontetrachloride, methylenechloride, dichlorethane, chlorobenzene, alcohols, nitromethan, acetonitrile, dimethylforamide, 1,4-dioxane, tetrahydrofuran (THF), methylcyclohexane (MCH), and any combination thereof

In some embodiments, at least one electrically resistive substitute (R2) of the composite organic compound is C_{X}Q_{2X+1}, where X≧1 and Q is hydrogen (H), fluorine (F), or chlorine (Cl). In another embodiment of the composite organic compound, at least one electrically resistive substitute (R2) is selected from the list comprising —(CH₂)ₙ—CH₃, —CH((CH—₂)ₙCH₃)₂) (where n≧1), alkyl, aryl, substituted alkyl, substituted aryl, branched alkyl, branched aryl, and any combination thereof and wherein the alkyl group is selected from methyl, ethyl, propyl, butyl, I-butyl and t-butyl groups, and the aryl group is selected from phenyl, benzyl and naphthyl groups. In yet another embodiment of the composite organic compound.

In some embodiments, at least one electrically resistive substitute (R2) is selected from the group of alkyl, aryl, substituted alkyl, substituted aryl, fluorinated alkyl, chlorinated alkyl, branched and complex alkyl, branched and complex fluorinated alkyl, branched and complex chlorinated alkyl groups, and any combination thereof, and wherein the alkyl group is selected from methyl, ethyl, propyl, n-butyl, iso-butyl and tent-butyl groups, and the aryl group is selected from phenyl, benzyl and naphthyl groups or siloxane, and/or polyethyleneglycol as linear or branched chains.

In some embodiments, the substitute R1 and/or R2 is connected to the aromatic polycyclic conjugated molecule (Core) via at least one connecting group. The at least one connecting group may be selected from the list comprising the following structures: 31-41 as given in Table 3, where W is hydrogen (H) or an alkyl group.

TABLE 3
Examples of the connecting group

| | |
|---|---|
| 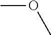 | 31 |
| 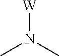 | 32 |
| 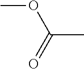 | 33 |
| 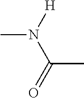 | 34 |
| 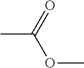 | 35 |
| 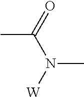 | 36 |
| 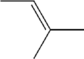 | 37 |
| 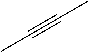 | 38 |
| 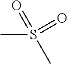 | 39 |
| 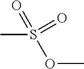 | 40 |
| 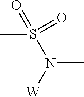 | 41 |

In some embodiments, the substitute R3 and/or R4 may be connected to the aromatic polycyclic conjugated molecule (Core) via at least one connecting group. The at least one connecting group may be selected from the list comprising CH₂, CF₂, SiR₂O, CH₂CH₂O, wherein R is selected from the list comprising H, alkyl, and fluorine. In another embodiment of the composite organic compound, the one or more ionic groups include at least one ionic group selected from the list comprising [NR₄]⁺, [PR₄]⁺ as cation and [—CO₂]⁻, [—SO₃]⁻, [—SR_{S}]⁻, [—PO₃R]⁻, [—PR₅]⁻ as anion, wherein R is selected from the list comprising H, alkyl, and fluorine.

The Sharp polymers have hyperelectronic or ionic type polarizability. “Hyperelectronic polarization may be considered due to the pliant interaction of charge pairs of excitons, localized temporarily on long, highly polarizable molecules, with an external electric field [.] (Roger D. Hartman and Herbert A. Pohl, “Hyper-electronic Polarization in Macromolecular Solids”, Journal of Polymer Science: Part A-1 Vol. 6, pp. 1135-1152 (1968)).” Ionic type polarization can be achieved by limited mobility of ionic parts of the tethered/partially immobilized ionic liquid or zwitterion (Q). Additionally, other mechanisms of polarization such as dipole polarization and monomers and polymers possessing metal conductivity may be used independently or in combination with hyper-electronic and ionic polarization in aspects of the present disclosure.

In another aspect, the present disclosure provides a meta-dielectric, wherein a meta-dielectric is a dielectric that includes one or more Sharp polymers in the form of a composite organic compound characterized by polarizability and resistivity having the above general structural formula.

Further, characteristics of meta-dielectrics include a relative permittivity greater than or equal to 1,000 and resistivity greater than or equal to 10¹⁶ ohm·cm. Individually, the Sharp Polymers in a meta-dielectric may form column like supramolecular structures by pi-pi interaction. Said supramolecules of Sharp polymers allow formation of crystal structures of the meta-dielectric material. By way of using Sharp polymers in a dielectric material, polarization units are incorporated to provide the molecular material with high dielectric permeability. There are several mechanisms of polarization such as dipole polarization, ionic polarization, and hyper-electronic polarization of molecules, monomers and polymers possessing metal conductivity. All polarization units with the listed types of polarization may be used in aspects of the present disclosure. Further, Sharp polymers are composite materials which incorporate an envelope of insulating substituent groups that electrically isolate the supramolecules from each other in the dielectric crystal layer and provide high breakdown voltage of the energy storage molecular material. Said insulating substituent groups are resistive alkyl or fluro-alkyl chains covalently bonded to a polarizable core, forming the resistive envelope.

In order that the invention may be more readily understood, reference is made to the following examples, which are intended to be illustrative of the invention, but are not intended to be limiting the scope.

### EXAMPLE 1

This Example describes synthesis of one type of Sharp polymer according following structural scheme:

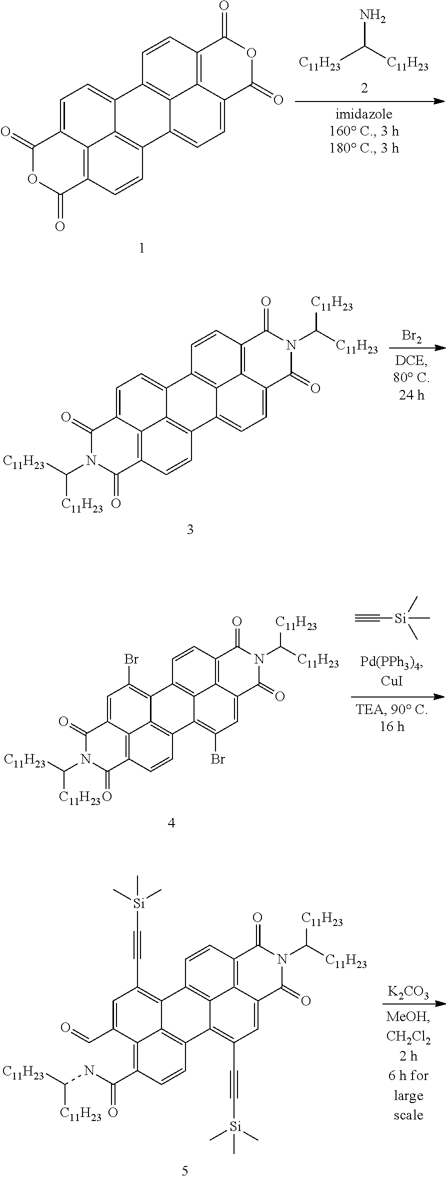

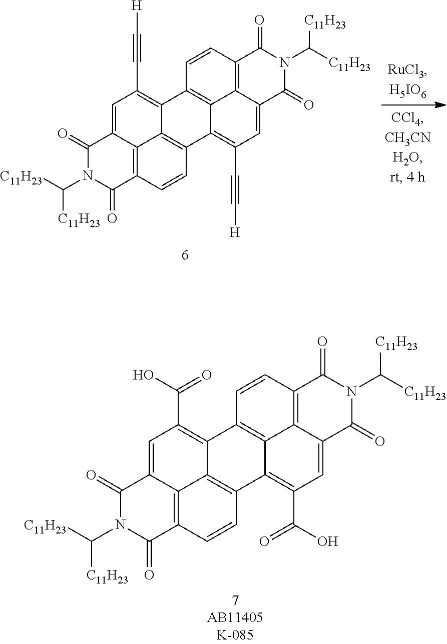

The process involved in the synthesis in this example may be understood in terms of the following five steps.

a) First Step:

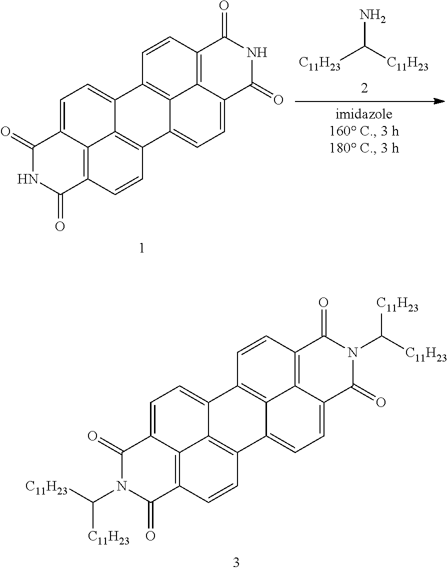

Anhydride 1 (60.0 g, 0.15 mol, 1.0 eq), amine 2 (114.4 g, 0.34 mol, 2.2 eq) and imidazole (686.0 g, 10.2 mol, 30 eq to 2) were mixed well into a 500 mL of round-bottom flask equipped with a bump-guarder. The mixture was degassed three times, stirred at 160° C. for 3 hr, 180° C. for 3 hr, and cooled to rt. The reaction mixture was crushed into water (1000 mL) with stirring. Precipitate was collected with filtration, washed with water (2×500 mL), methanol (2×300 mL) and dried on high vacuum. The crude product was purified by flash chromatography column (CH₂Cl₂/hexane=1/1) to give 77.2 g (48.7%) of the desired product 3 as an orange solid. ¹H NMR (300 MHz, CDCl₃) δ 8.65-8.59 (m, 8H), 5.20-5.16 (m, 2H), 2.29-2.22 (m, 4H), 1.88-1.82 (m, 4H), 1.40-1.13 (m, 64H), 0.88-0.81 (t, 12H). Rf=0.68 (CH₂Cl₂/hexane=1/1).

b) Second Step:

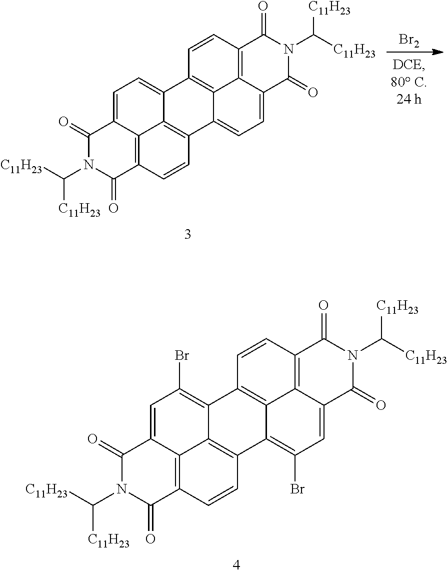

To a solution of the diimide 3 (30.0 g, 29.0 mmol, 1.0 eq) in dichloroethane (1500 mL) was added bromine (312.0 g, 1.95 mol, 67.3 eq). The resulting mixture was stirred at 80° C. for 36 hr, cooled, washed with 10% NaOH (aq, 2×1000 mL), water (100 ml), dried over Na₂SO₄, filtered and concentrated. The crude product was purified by flash chromatography column (CH₂Cl₂/hexanes=1/1) to give 34.0 g (98.2%) of the desired product 4 as a red solid. ¹H NMR (300 MHz, CDCl₃) δ 9.52 (d, 2H), 8.91 (bs, 2H), 8.68 (bs, 2H), 5.21-5.13 (m, 2H), 2.31-2.18 (m, 4H), 1.90-1.80 (m, 4H), 1.40-1.14 (m, 64H), 0.88-0.81 (t, 12H). Rf=0.52 (CH₂Cl₂/hexanes=1/1).

c) Third Step

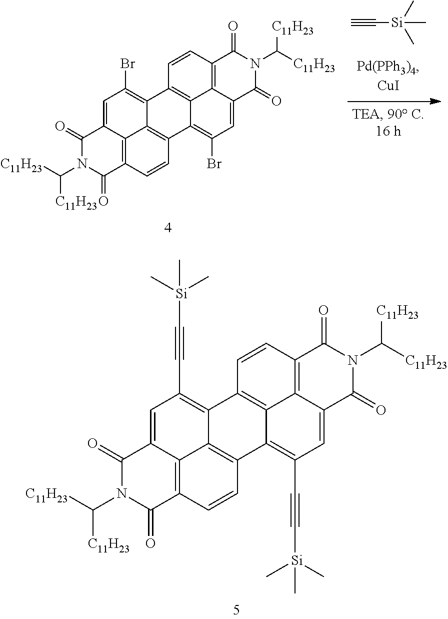

To a solution of the di-bromide 4 (2.0 g, 1.68 mmol, 1.0 eq) in triethylamine (84.0 mL) was added CuI (9.0 mg, 0.048 mmol, 2.8 mol %) and (trimethylsilyl)acetylene (80.49 g, 5.0 mmol, 3.0 eq). The mixture was degassed three times. Catalyst Pd(PPh₃)₄ (98.0 mg, 0.085 mmol, 5.0 mol %) was added. The mixture was degassed three times, stirred at 90° C. for 24 hr, cooled, passed through a pad of Celite, and concentrated. The crude product was purified by flash chromatography column (CH₂Cl₂/hexane=1/1) to give 1.8 g (87.2%) of the desired product 5 as a dark-red solid. ¹H NMR (300 MHz, CDCl₃) δ 10.24-10.19 (m, 2H), 8.81 (bs, 2H), 8.65 (bs, 2H), 5.20-5.16 (m, 2H), 2.31-2.23 (m, 4H), 1.90-1.78 (m, 4H), 1.40-1.15 (m, 72H), 0.84-0.81 (t, 12H), 0.40 (s, 18H). Rf=0.72 (CH₂Cl₂/hexane=1/1).

d) Fourth Step

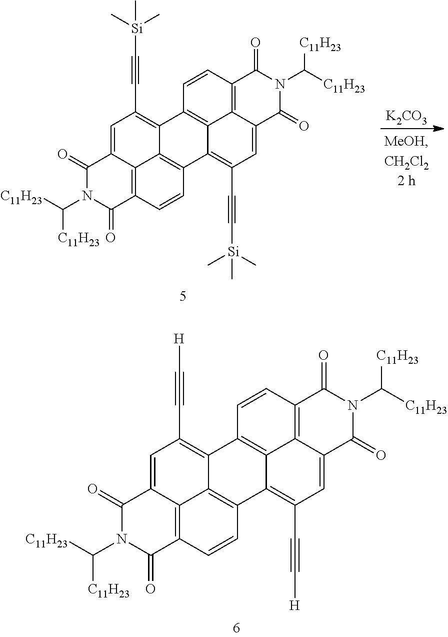

To a solution of diimide 5 (1.8 g, 1.5 mmol, 1.0 eq) in a mixture of MeOH/DCM (40.0 mL/40.0 mL) was added K₂CO₃ (0.81 g, 6.0 mmol, 4.0 eq). The mixture was stirred at room temperature for 1.5 hr, diluted with DCM (40.0 mL), washed with water, brine, dried over Na₂SO₄, filtered and concentrated. The crude product was purified by flash chromatography column (CH₂Cl₂) to give 1.4 g (86.1%) of the desired product 6 as a dark-red solid. ¹H NMR (300 MHz, CDCl₃) δ 10.04-10.00 (m, 2H), 8.88-8.78 (m, 2H), 8.72-8.60 (m, 2H), 5.19-5.14 (m, 2H), 3.82-3.80 (m, 2H), 2.31-2.23 (m, 4H), 1.90-1.78 (m, 4H), 1.40-1.05 (m, 72H), 0.85-0.41 (t, 12H). Rf=0.62 (CH₂Cl₂).

e) Fifth Step

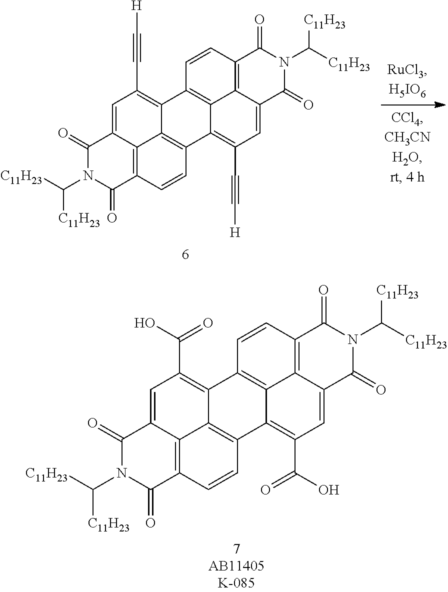

To a suspension of alkyne 6 (1.4 g, 1.3 mmol, 1.0 eq) in a mixture of CCl₄/CH₃CN/H₂O (6 mL/6 mL/12 mL) was added periodic acid (2.94 g, 12.9 mmol, 10.0 eq) and RuCl₃ (28.0 mg, 0.13 mmol, 10 mol %). The mixture was stirred at room temperature under nitrogen for 4 hours, diluted with DCM (50 mL), washed with water, brine, dried over Na₂SO₄, filtered and concentrated. The crude product was purified by flash chromatography column (10% MeOH/CH₂Cl₂) to give 1.0 g (68.5%) of the desired product 7 as a dark-red solid. ¹H NMR (300 MHz, CDCl₃) δ 8.90-8.40 (m, 6H), 5.17-5.00 (m, 2H), 2.22-2.10 (m, 4H), 1.84-1.60 (m, 4H), 1.41-0.90 (m, 72H), 0.86-0.65 (t, 12H). Rf=0.51 (10% MeOH/CH₂Cl₂).

### EXAMPLE 2

This Example describes synthesis of a Sharp polymer according following structural scheme:

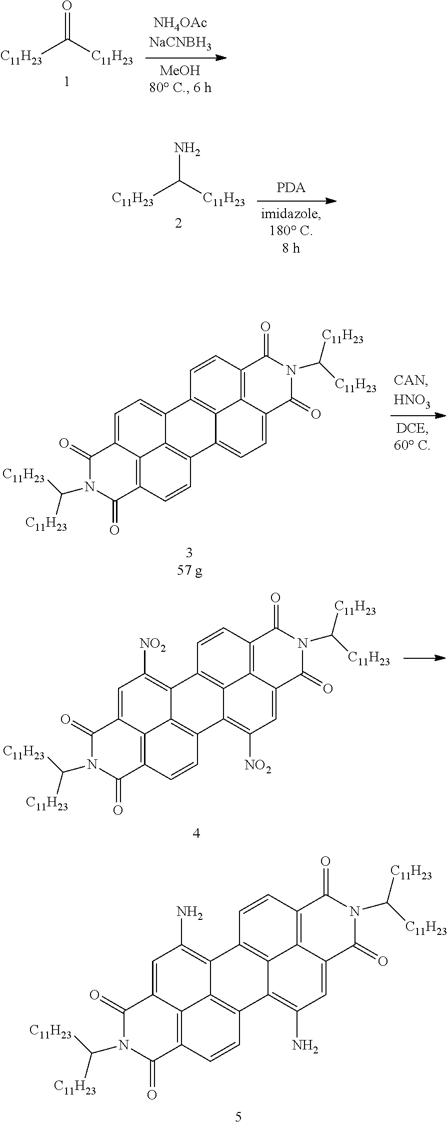

The process involved in the synthesis in this example may be understood in terms of the following four steps.

a) First Step:

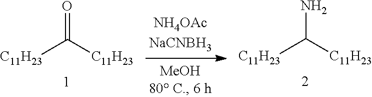

To a solution of the ketone 1 (37.0 g, 0.11 mol, 1.0 eq) in methanol (400 mL) was added ammonium acetate (85.3 g, 1.11 mol, 10.0 eq) and NaCNBH₃ (28.5 g, 0.44 mol, 4.0 eq) in portions. The mixture was stirred at reflux for 6 hours, cooled to room temperature and concentrated. Sat. NaHCO₃ (500 mL) was added to the residue and the mixture was stirred at room temperature for 1 hour. Precipitate was collected by filtration, washed with water (4×100 mL), dried on a high vacuum to give 33.6 g (87%) of the amine 2 as a white solid.

b) Second Step:

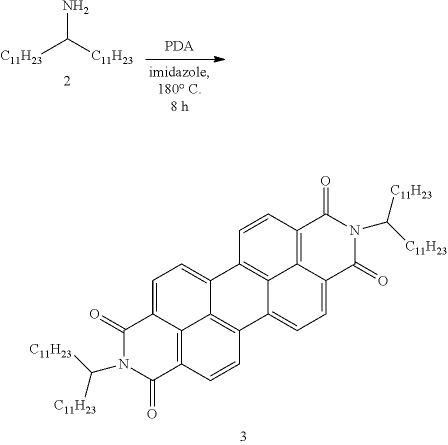

Mixed well the amine 2 (20.0 g, 58.7 mmol, 2.2 equ), 3,4,9,10-perylenetetracarboxylic dianhydride (10.5 g, 26.7 mmol, 1.0 eq) and imidazole (54.6 g, 0.80 mmol, 30 eq to diamine) into a 250 mL round-bottom flask equipped with a rotavap bump guard. The mixture was degased (vacuum and fill with N₂) three times and stirred at 160° C. for 6 hrs. After cooling to rt, the reaction mixture was crushed into water (700 mL), stirred for 1 hr, and filtered through a filter paper to collected precipitate which was washed with water (3×300 mL) and mthanol (3×300 mL), dried on a high vacum to give 23.1 g (83.5%) of the diamidine 3 as a orange solid. Pure diamidine 3 (20.6 g) was obtained by flash chromatography column (DCM/hexanes=1/1).

c) Third Step:

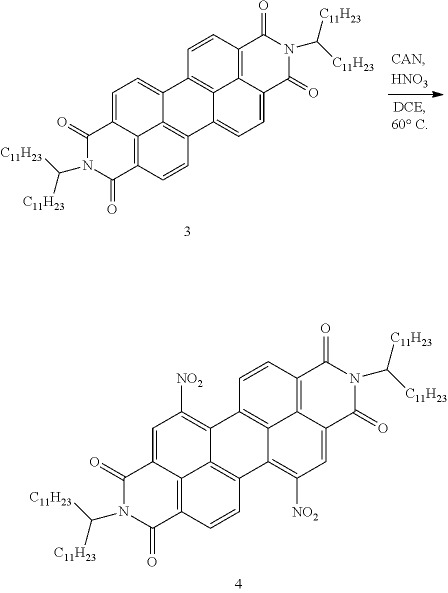

To DCE (2.0 L) was added compound 3 (52.0 g, 50.2 mmol, 1.0 eq), acetic acid (500 mL) and fuming nitric acid (351.0 g, 5.0 mol, 100.0 eq) with caution. To the mixture was added ammonium cerium(IV) nitrate (137.0 g, 0.25 mol, 5.0 eq). The reaction was stirred at 60° C. for 48 hrs. After cooling to rt, the reaction mixture was crushed into water (1.0 L). The organic phase was washed with water (2×1.0 L), saturated NaHCO3 solution (1×1.0 L) and brine (1×1.0 L), dried over sodium sulfate, filtered and concentrated. The residue was purified with column chromatography to give 46.7 g (82%) of compound 4 as a dark red solid. ¹H NMR (300 MHz, CDCl₃) δ 0.84 (t, 12H), 1.26 (m, 72H), 1.83 (m, 4H), 2.21 (m, 4H), 5.19 (m, 2H), 8.30 (m, 2H), 8.60-8.89 (m, 4H).

d) Fourth Step:

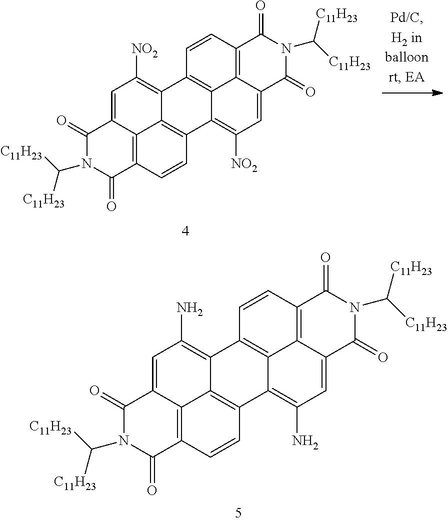

A mixture of compound 4 (25 g, 22.2 mmol, 1.0 eq) and Pd/C (2.5 g, 0.1 eq) in EtOAc (125.0 mL) was stirred at room temperature for 1 hour. The solid was filtered off (Celite) and washed with EtOAc (5 mL×2). The filtrate was concentrated to afford the compound 5 (23.3 g, 99%) as a dark blue solid. ¹H NMR (300 MHz, CDCl₃) δ 0.84 (t, 12H), 1.24 (m, 72H), 1.85 (m, 4H), 2.30 (m, 4H), 5.00 (s, 2H), 5.10 (s, 2H), 5.20 (m, 2H), 7.91-8.19 (dd, 2H), 8.40-8.69 (dd, 2H), 8.77-8.91 (dd, 2H).

Furuta co-polymers and para-Furuta polymers, herein referred to collectively as Furuta Polymers unless otherwise specified, are polymeric compounds with insulating tails, and linked/tethered/partially immobilized polarizable ionic groups. The insulating tails are hydrocarbon (saturated and/or unsaturated), fluorocarbon, siloxane, and/or polyethylene glycol linear or branched chains covalently bonded to the co-polymer backbone. The tails act to insulate the polarizable tethered/partially immobilized ionic molecular components and ionic pairs from other ionic groups and ionic group pairs on the same or parallel co-polymers, which favorably allows discrete polarization of counter ionic liquid pairs or counter Q groups (i.e. polarization of cationic liquid and anionic liquid tethered/partially immobilized to parallel Furuta polymers) with limited or no interaction of ionic fields or polarization moments of other counter ionic group pairs partially immobilized on the same or parallel co-polymer chains. Further, the insulating tails electrically insulate supra-structures of Furuta polymers from each other. Parallel Furuta polymers may arrange or be arranged such that counter ionic groups (i.e. tethered/partially immobilized ionic groups (Qs) of cation and anion types (sometimes known as cationic Furuta polymers and anionic Furuta polymers)) are aligned opposite from one another.

A Furuta co-polymer has the following general structural formula:

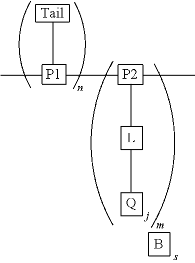

From the Furuta co-polymer general structural formula above, the backbone structure of the co-polymer comprises structural units of first type P1 and structural units of second type P2 both of which randomly repeat and are independently selected from the list comprising acrylic acid, methacrylate, repeat units of polypropylene (—[CH₂—CH(CH₃)]—), repeat units of polyethylene (—[CH₂]—), siloxane, or repeat units of polyethylene terephthalate (sometimes written poly(ethylene terephthalate)) for which the repeat unit may be expressed as —CH₂—CH₂—O—CO—C₆H₄—CO—O—. Parameter “n” is the number of the P1 structural units in the backbone structure which is in the range from 3 to 100,000 and “m” is the number of the P2 structural units in the backbone structure which is in the range from 3 to 100,000. Further, the first type of structural unit (P1) has a resistive substitute Tail which is oligomers of polymeric material with HOMO-LUMO gap no less than 2 eV. Additionally, the second type of structural units (P2) has an ionic functional group Q which is connected to P2 via a linker group L. The parameter “j” is a number of functional groups Q attached to the linker group L, which may range from 0 to 5. The ionic functional group Q comprises one or more ionic liquid ions (from the class of ionic compounds that are used in ionic liquids), zwitterions, or polymeric acids. Further, an energy interaction of the ionic Q groups may be less than kT, where “k” is Boltzmann constant and T is the temperature of environment. Still further, parameter “B” is a counter ion which is a molecule or molecules or oligomers that can supply the opposite charge to balance the charge of the co-polymer, wherein “s” is the number of the counter ions.

The present disclosure provides an organic co-polymeric compound having the structure described above. In one embodiment of the organic co-polymeric compound, the resistive substitute Tails are independently selected from the list comprising oligomers of polypropylene (PP), oligomers of polyethylene terephthalate (PET), oligomers of polyphenylene sulfide (PPS), oligomers of polyethylene naphthalate (PEN), oligomers of polycarbonate (PP), polystyrene (PS), and oligomers of polytetrafluoroethylene (PTFE). In another embodiment of the organic co-polymeric compound, the resistive substitutes Tail are independently selected from alkyl, aryl, substituted alkyl, substituted aryl, fluorinated alkyl, chlorinated alkyl, branched and complex alkyl, branched and complex fluorinated alkyl, branched and complex chlorinated alkyl groups, and any combination thereof, and wherein the alkyl group is selected from methyl, ethyl, propyl, butyl, iso-butyl and tent-butyl groups, and the aryl group is selected from phenyl, benzyl and naphthyl groups. The resistive substitute Tail may be added after polymerization.

In yet another aspect of the present disclosure, it is preferable that the HOMO-LUMO gap is no less than 4 eV. In still another aspect of the present disclosure, it is even more preferable that the HOMO-LUMO gap is no less than 5 eV. The ionic functional group Q comprises one or more ionic liquid ions from the class of ionic compounds that are used in ionic liquids, zwitterions, or polymeric acids. The energy of interaction between Q group ions on discrete P₂ structural units may be less than kT, where k is Boltzmann constant and T is the temperature of environment. The temperature of environment may be in range between −60 C of and 150 C. The preferable range of temperatures is between −40 C and 100 C. Energy interaction of the ions depends on the effective radius of ions. Therefore, by increasing the steric hindrance between ions it is possible to reduce energy of interaction of ions. In one embodiment of the present invention, at least one ionic liquid ion is selected from the list comprising [NR₄]⁺, [PR₄]⁺ as cation and [—CO₂]⁻, [—SO₃]⁻, [—SR₅]⁻, [—PO₃R]⁻, [—PR₅]⁻ as anion, wherein R is selected from the list comprising H, alkyl, and fluorine. The functional group Q may be charged after or before polymerization. In another embodiment of the present invention, the linker group L is oligomer selected from structures 42 to 47 as given in Table 3.

TABLE 3
Examples of the oligomer linker group

| | |
|---|---|
| 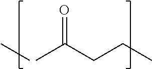 | 42 |
| 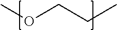 | 43 |
| 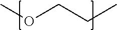 | 44 |
| 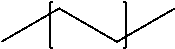 | 45 |
| 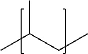 | 46 |
| 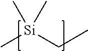 | 47 |

In yet another embodiment of the present invention, the linker group L is selected from structures 48 to 56 as given in Table 4.

TABLE 4
Examples of the linker group

| | |
|---|---|
| 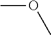 | 48 |
| 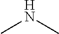 | 49 |
| 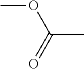 | 50 |
| 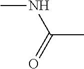 | 51 |
| 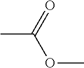 | 52 |
| 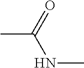 | 53 |
| 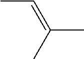 | 54 |
| 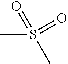 | 55 |
| 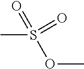 | 56 |

In yet another embodiment of the present invention, the linker group L may be selected from the list comprising CH₂, CF₂, SiR₂O, and CH2CH2O, wherein R is selected from the list comprising H, alkyl, and fluorine. The ionic functional group Q and the linker groups L may be added after polymerization.

In another aspect, the present disclosure provides a dielectric material (sometimes called a meta-dielectric) comprising of one or more of the class of Furuta polymers comprising protected or hindered ions of zwitterion, cation, anion, or polymeric acid types described hereinabove. The meta-dielectric material may be a mixture of zwitterion type Furuta polymers, or positively charged (cation) Furuta polymers and negatively charged (anion) Furuta polymers, polymeric acid Furuta polymers, or any combination thereof. The mixture of Furuta polymers may form or be induced to form supra-structures via hydrophobic and ionic interactions. By way of example, but not limiting in scope, the cation on a positively charged Furuta polymer replaces the B counter ions of the anion on a negatively charged Furuta polymer parallel to the positively charged Furuta polymer and vice versa; and the resistive Tails of neighboring Furuta polymers further encourages stacking via van der Waals forces, which increases ionic group isolation. Meta-dielectrics comprising both cationic and anionic Furuta polymers have a 1:1 ratio of cationic and anionic Furuta polymers.

The Tails of hydrocarbon (saturated and/or unsaturated), fluorocarbon, siloxane, and/or polyethylene glycol linear or branched act to insulate linked/tethered/partially immobilized polarizable ionic liquids, zwitterions, or polymeric acids (ionic Q groups). The Tails insulate the ionic Q groups from other ionic Q groups on the same or parallel Furuta polymer via steric hindrance of the ionic Q groups' energy of interaction, which favorably allows discrete polarization of the ionic Q groups (i.e. polarization of cationic liquid and anionic liquid tethered/partially immobilized to parallel Furuta polymers). Further, the Tails insulate the ionic groups of supra-structures from each other. Parallel Furuta polymers may arrange or be arranged such that counter ionic liquids (i.e. tethered/partially immobilized ionic liquids (Qs) of cation and anion types) are aligned opposite from one another (sometimes known as cationic Furuta polymers and anionic Furuta polymers).

The Furuta polymers have hyperelectronic or ionic type polarizability. “Hyperelectronic polarization may be considered due to the pliant interaction of charge pairs of excitons, localized temporarily on long, highly polarizable molecules, with an external electric field [.] (Roger D. Hartman and Herbert A. Pohl, “Hyper-electronic Polarization in Macromolecular Solids”, Journal of Polymer Science: Part A-1 Vol. 6, pp. 1135-1152 (1968)).” Ionic type polarization can be achieved by limited mobility of ionic parts of the tethered/partially immobilized ionic liquid or zwitterion (Q). Additionally, other mechanisms of polarization such as dipole polarization and monomers and polymers possessing metal conductivity may be used independently or in combination with hyper-electronic and ionic polarization in aspects of the present disclosure.

Further, a meta-dielectric layer may be comprised of one or more types of zwitterion Furuta polymer and/or selected from the anionic Q⁺ group types and cationic Q⁻ group types and/or polymeric acids, having the general configuration of Furuta polymers:

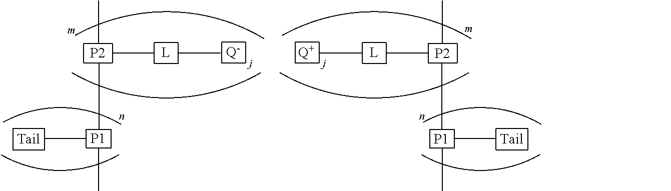

In order that the invention may be more readily understood, reference is made to the following examples of synthesis of Furuta co-polymers, which are intended to be illustrative of the invention, but are not intended to be limiting the scope.

### EXAMPLE 3

Carboxylic acid co-polymer P002. To a solution of 1.02 g (11.81 mmol) of methacrylic acid and 4.00 g (11.81 mmol) of stearylmethacrylate in 2.0 g isopropanol was added a solution of 0.030 g 2,2′-azobis(2-methylpropionitrile) (AIBN) in 5.0 g of toluene. The resulting solution was heated to 80 C for 20 hours in a sealed vial, after which it became noticeably viscous. NMR shows <2% remaining monomer. The solution was used without further purification in film formulations and other mixtures.

### EXAMPLE 4

Amine co-polymer P011. To a solution of 2.52 g (11.79 mmol) of 2-(diisopropylamino)ethyl methacrylate and 3.00 g (11.79 mmol) of laurylmethacrylate in 2.0 g toluene was added a solution of 0.030 g 2,2′-azobis(2-methylpropionitrile) (AIBN) in 4.0 g of toluene. The resulting solution was heated to 80 C for 20 hours in a sealed vial, after which it became noticeably viscous. NMR shows <2% remaining monomer. The solution was used without further purification in film formulations and other mixtures.

### EXAMPLE 5

Carboxylic acid co-polymer and amine co-polymer mixture. 1.50 g of a 42 wt % by solids solution of P002 was added to 1.24 g of a 56 wt % solution of P011 with 1 g of isopropanol and mixed at 40 C for 30 minutes. The solution was used without further purification.

A para-Furuta polymer has repeat units of the following general structural formula:

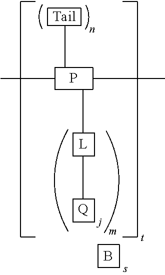

From the para-Furuta polymer general structural formula above, a structural unit P comprises a backbone of the copolymer, which is independently selected from the list comprising acrylic acid, methacrylate, repeat units for polypropylene (PP) (—[CH₂—CH(CH₃)]—), repeat units for polyethylene (PE) (—[CH₂]—), siloxane, or repeat units of polyethylene terephthalate (sometimes written poly(ethylene terephthalate)) for which the repeat unit may be expressed as —CH₂—CH₂—O—CO—C₆H₄—CO—O—, wherein the first type of repeat unit (Tail) is a resistive substitute in the form of an oligomer of a polymeric material. The resistive substitute preferably has a HOMO-LUMO gap no less than 2 eV. The parameter “n” is a number of Tail repeat units on the backbone P structural unit, and is in the range from 3 to 100,000. Further, the second type of repeat units (-L-Q) include an ionic functional group Q which is connected to the structural backbone unit (P) via a linker group L, and “m” is number of the -L-Q repeat units in the backbone structure which is in the range from 3 to 100,000. Additionally, the ionic functional group Q comprises one or more ionic liquid ions (from the class of ionic compounds that are used in ionic liquids), zwitterions, or polymeric acids. An energy of interaction of the ionic Q groups may be less than kT, where “k” is Boltzmann constant and T is the temperature of environment. Still further, the parameter “t” is average of para-Furuta polymer repeat units, ranging from 6 to 200,000. “B” is a counter ion which is a molecule or an oligomer that can supply the opposite charge to balance the charge of the co-polymer, and “s” is the number of the counter ions.

The present disclosure provides an organic polymeric compound. In one embodiment of the organic polymeric compound, the resistive substitute Tails are independently selected from the list comprising polypropylene (PP), polyethylene terephthalate (PET), polyphenylene sulfide (PPS), polyethylene naphthalate (PEN), polycarbonate (PP), polystyrene (PS), and polytetrafluoroethylene (PTFE). In another embodiment of the organic polymeric compound, the resistive substitutes Tail are independently selected from alkyl, aryl, substituted alkyl, substituted aryl, fluorinated alkyl, chlorinated alkyl, branched and complex alkyl, branched and complex fluorinated alkyl, branched and complex chlorinated alkyl groups, and any combination thereof, and wherein the alkyl group is selected from methyl, ethyl, propyl, butyl, iso-butyl and tent-butyl groups, and the aryl group is selected from phenyl, benzyl and naphthyl groups. The resistive substitute Tail may be added after polymerization. In yet another embodiment of the present disclosure, it is preferable that the HOMO-LUMO gap is no less than 4 eV. In still another embodiment of the present disclosure, it is even more preferable that the HOMO-LUMO gap is no less than 5 eV. The ionic functional group Q comprises one or more ionic liquid ions from the class of ionic compounds that are used in ionic liquids, zwitterions, or polymeric acids. Energy of interaction between Q group ions on discrete P structural units may be less than kT, where k is Boltzmann constant and T is the temperature of environment. The temperature of environment may be in range between −60 C of and 150 C. The preferable range of temperatures is between −40 C and 100 C. Energy interaction of the ions depends on the effective radius of ions. Therefore, by increasing the steric hindrance between ions it is possible to reduce energy of interaction of ions. In one embodiment of the present invention, at least one ionic liquid ion is selected from the list comprising [NR₄]⁺, [PR₄]⁺ as cation and [—CO₂]⁻, [—SO₃]⁻, [—SR₅]⁻, [—PO₃R]⁻, [—PR₅]⁻ as anion, wherein R is selected from the list comprising H, alkyl, and fluorine. The functional group Q may be charged after or before polymerization. In another embodiment of the present invention, the linker group L is oligomer selected from structures 42 to 47 as given in Table 3 or structures 48 to 56 in Table 4.

In yet another embodiment of the present invention, the linker group L is selected from the list comprising CH₂, CF₂, SiR₂O, and CH2CH2O, wherein R is selected from the list comprising H, alkyl, and fluorine. The ionic functional group Q and the linker groups L may be added after polymerization.

In another aspect, the present disclosure provides a dielectric material (sometimes called a meta-dielectric) comprising of one or more of the class of para-Furuta polymers comprising protected or hindered ions of zwitterion, cationic liquid ions, anionic liquid ions, or polymeric acid types described hereinabove. The meta-dielectric material may be a mixture of zwitterion type para-Furuta polymers, or positively charged (cation) para-Furuta polymers and negatively charged (anion) para-Furuta polymers, polymeric acid para-Furuta polymers, or any combination thereof. The mixture of para-Furuta polymers may form or be induced to form supra-structures via hydrophobic and ionic interactions. By way of example, but not limiting in scope, the cation(s) on a positively charged para-Furuta polymer replaces the B counter ions of the anion(s) on a negatively charged para-Furuta polymer parallel to the positively charged para-Furuta polymer and vice versa; and the resistive Tails of neighboring para-Furuta polymers further encourages stacking via van der Waals forces, which increases ionic group isolation. Meta-dielectrics comprising both cationic and anionic para-Furuta polymers preferably have a 1:1 ratio of cationic and anionic para-Furuta polymers.

The Tails of hydrocarbon (saturated and/or unsaturated), fluorocarbon, siloxane, and/or polyethylene glycol linear or branched act to insulate linked/tethered/partially immobilized polarizable ionic liquids, zwitterions, or polymeric acids (ionic Q groups). The Tails insulate the ionic Q groups from other ionic Q groups on the same or parallel para-Furuta polymer via steric hindrance of the ionic Q groups' energy of interaction, which favorably allows discrete polarization of the ionic Q groups (i.e. polarization of cationic liquid and anionic liquid tethered/partially immobilized to parallel para-Furuta polymers). Further, the Tails insulate the ionic groups of supra-structures from each other. Parallel para-Furuta polymers may arrange or be arranged such that counter ionic liquids (i.e. tethered/partially immobilized ionic liquids (Qs) of cation and anion types) are aligned opposite from one another (sometimes known as cationic para-Furuta polymers and anionic para-Furuta polymers).

The para-Furuta polymers have hyperelectronic or ionic type polarizability. “Hyperelectronic polarization may be considered due to the pliant interaction of charge pairs of excitons, localized temporarily on long, highly polarizable molecules, with an external electric field [.] (Roger D. Hartman and Herbert A. Pohl, “Hyper-electronic Polarization in Macromolecular Solids”, Journal of Polymer Science: Part A-1 Vol. 6, pp. 1135-1152 (1968)).” Ionic type polarization can be achieved by limited mobility of ionic parts of the tethered/partially immobilized ionic liquid or zwitterion (Q). Additionally, other mechanisms of polarization such as dipole polarization and monomers and polymers possessing metal conductivity may be used independently or in combination with hyper-electronic and ionic polarization in aspects of the present disclosure.

Further, a meta-dielectric layer may be comprised of one or more types of zwitterion para-Furuta polymer and/or selected from the anionic Q group types and cationic Q group types and/or polymeric acids, which may have the following general arrangement of para-Furuta polymers:

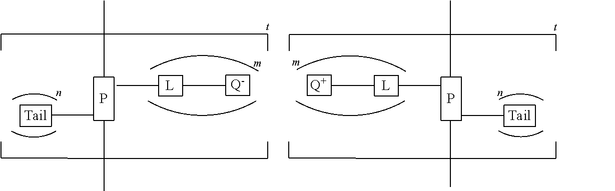

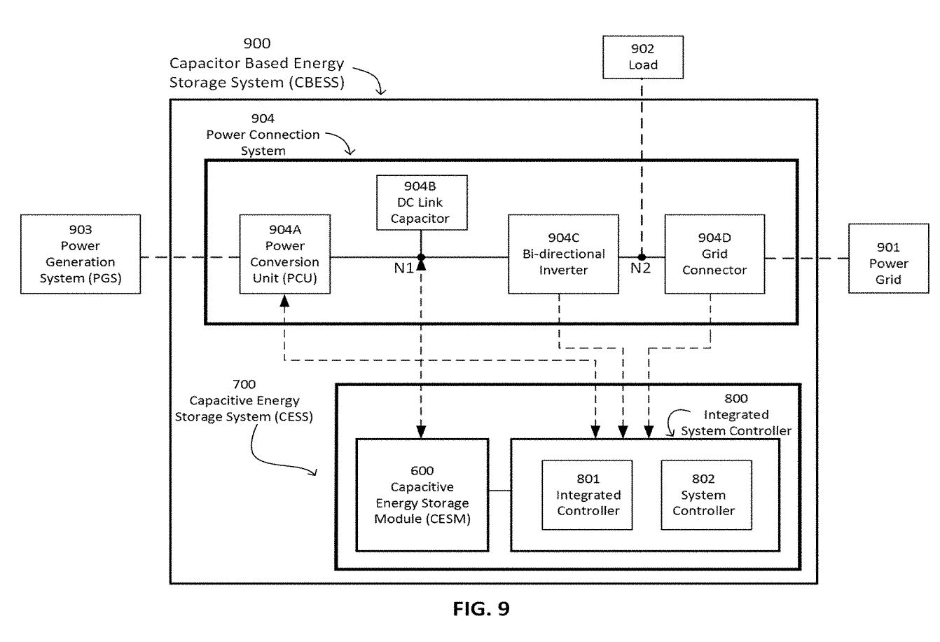

The present invention, which is the Capacitor Based Energy Storage System (CBESS) 900, is shown in block diagram form in FIG. 9. Before discussing the general functionality of the present invention, certain blocks in FIG. 9 must first be addressed. Specifically, the elements and sub-elements of the Capacitive Energy Storage System (CESS) 700, which comprises one or more CESM 600 and an Integrated System Controller 800, must first be addressed before discussing the general functionality of the invention, some of the invention's novel aspects, and some exemplary embodiments of the invention. Thus, the author uses paragraphs [0110]-[0123] to discuss the elements and sub-elements of CESM 600 and Integrated System Controller 800.

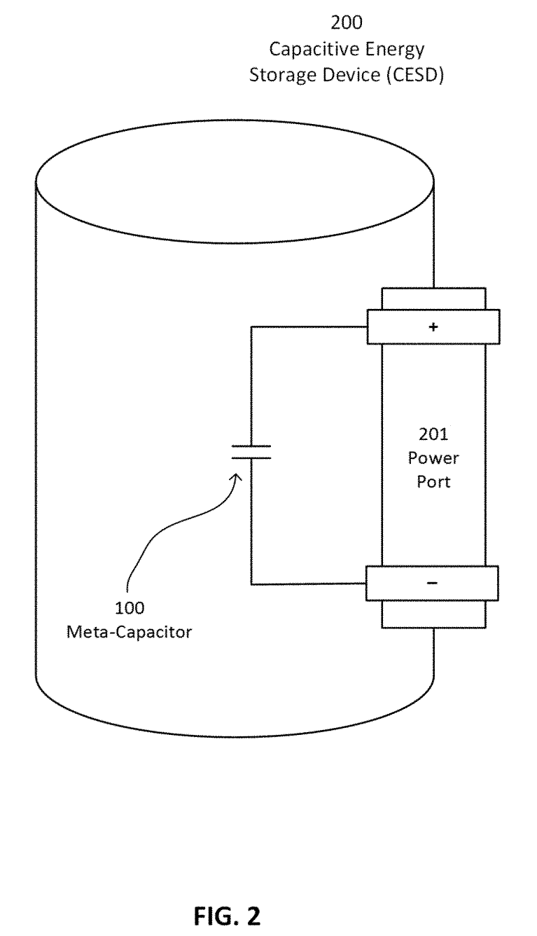

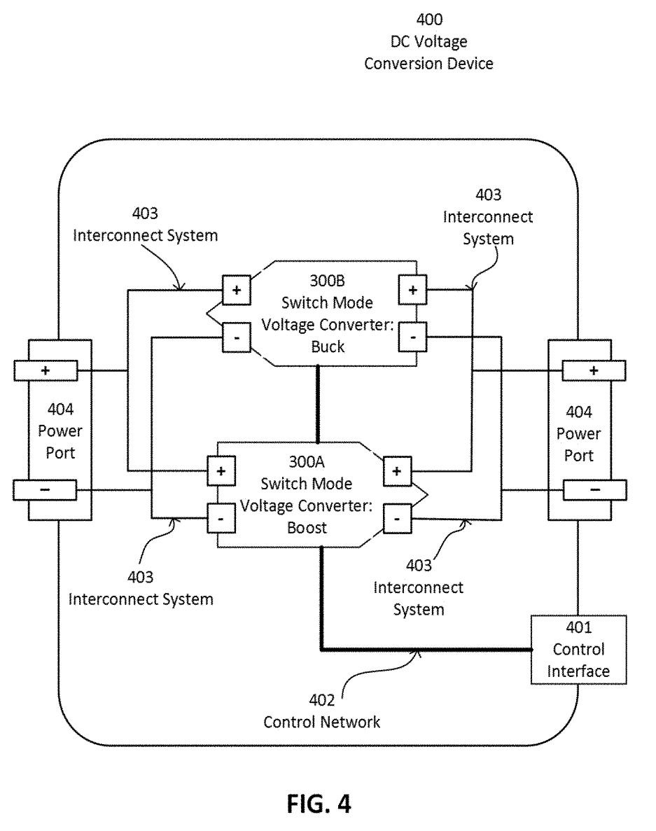

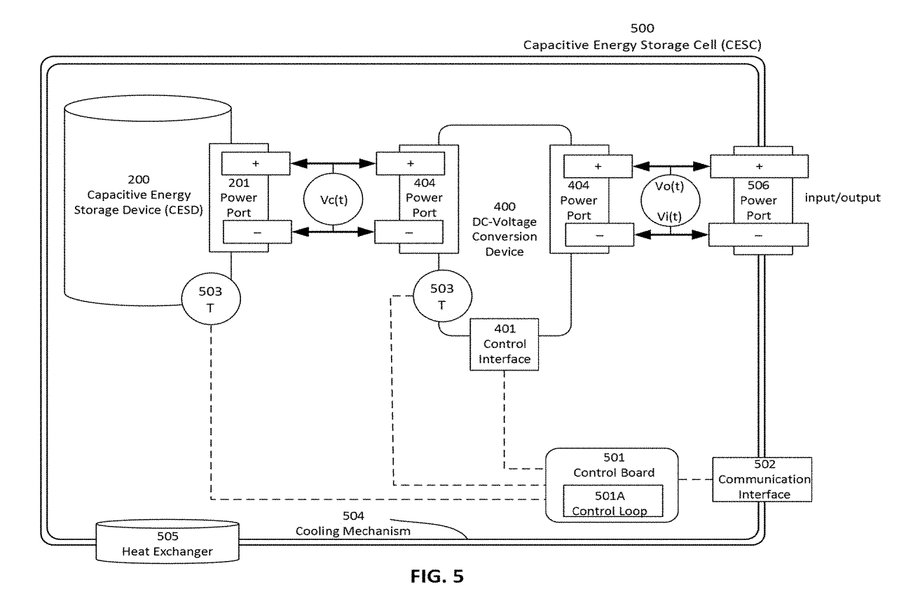

To address the problems and limitations of conventional rechargeable electrical energy storage technology, e.g., the use of rechargeable batteries, the present invention provides a capacitive energy storage cell comprising at least one capacitive energy storage device and a DC-voltage conversion device. A capacitive energy storage device includes at least one meta-capacitor. FIG. 5 schematically shows a Capacitive Energy Storage Cell (CESC) 500 comprising a Capacitive Energy Storage Device (CESD) 200, which is illustrated in FIG. 2, and a DC-Voltage Conversion Device 400, which is illustrated in FIG. 4.

The CESD 200 in the present invention includes one or more meta-capacitors. As shown in FIG. 1, Meta-Capacitor 100 comprises a First Electrode 101, a Second Electrode 102, and a Meta-Dielectric Material Layer 103 disposed between the first and second electrodes. Electrodes 101 and 102 may be made of a metal such as copper, zinc, aluminum, or other conductive material, and are generally planar in shape. In one implementation, Electrodes 101 and 102 and Meta-Dielectric Material Layer 103 are in the form of long strips of material that are sandwiched together and wound into a coil along with an insulating material, e.g., a plastic film such as polypropylene or polyester, to prevent electrical shorting between Electrodes 101 and 102. Examples of such coiled capacitor energy storage devices are described in detail in a commonly-assigned U.S. patent application (Ser. No. 14/752,600), filed 26 Jun. 2015, in which the entire disclosure is incorporated herein by reference. For simplicity, the CESD 200 in FIG. 2 is implemented using a single Meta-Capacitor 100, but the present disclosure is not limited to such implementation. For example, CESD 200 may include multiple meta-capacitors connected in parallel to provide a desired amount of energy storage capacity that scales roughly with the number of meta-capacitors. Alternatively, CESD 200 may include two or more meta-capacitors connected in series to accommodate a desired voltage level, or may include combinations of three or more meta-capacitors in a capacitor network involving various series and parallel combinations. For example, there may be three meta-capacitor combinations connected in parallel with each other with each combination having two capacitors connected in series.

Furthermore, the DC-voltage conversion device consists of one or more switch-mode voltage converters. For simplicity, the DC-Voltage Conversion Device 400 in FIG. 4 is implemented utilizing two different types of switch-mode voltage converters, i.e., Switch-Mode Voltage Converter: Boost 300A and Switch-Mode Voltage Converter: Buck 300B. However, the present disclosure is not limited to such implementation. For example, the DC-Voltage Conversion Device 400 may consist of one or more of the following switch-mode voltage converters: buck converter, boost converter, buck/boost converter, bi-directional buck/boost (split-pi) converter, Cuk converter, SEPIC converter, inverting buck/boast converter, four-switch buck/boost converter, etc.

In an embodiment of a Capacitive Energy Storage Cell (CESC) 500 shown in FIG. 5, the DC-Voltage Conversion Device 400 may be connected to a Control Board 501, which contains suitable logic circuitry, and an optional Communication Interface 502, as well as an analog to digital converter coupled to sensors on the DC-Voltage Conversion Device 400. For example, the sensors are as follow: voltage sensors for the input voltage Vi(t) and the output voltage Vo(t); current sensors for current to or from the CESD 200 or for current to or from the DC-Voltage Conversion Device 400; or temperature sensors T 503 on the CESD 200 or on the DC-Voltage Conversion Device 400. The logic circuitry in the Control Board 501, for example, may include a microprocessor, a microcontroller, an application specific integrated circuit (ASIC), a field programmable gate array (FPGA), or a complex programmable logic device (CPLD), capable of implementing closed Control Loop 501A processes. In some implementations, the Control Board 501 may be integrated into the DC-Voltage Conversion Device 400. The DC-Voltage Conversion Device 400 may contain a buck regulator; a boost regulator; buck and boast regulators with separate inputs/outputs; a bi-directional boost/buck regulator; or a split-pi converter. Control Board 501 may be configured to maintain a constant output voltage Vo(t) from the DC-Voltage Conversion Device 400 during discharge. Additionally, Control Board 501 may be configured to charge the meta-capacitors in CESD 200 at a more or less constant current while maintaining a stable input voltage.

Furthermore, in another implementation, CESC 500 may further comprise a Cooling Mechanism 504. The cooling can be passive, e.g., using radiative cooling fins on the CESD 200 and on the DC-Voltage Conversion Device 400. Alternatively, a fluid such as air, water or ethylene glycol can be used as a coolant in an active cooling system. By way of example, and not by way of limitation, the Cooling Mechanism 504 may include conduits in thermal contact with the CESD 200 and the DC-Voltage Conversion Device 400. The conduits are filled with a heat exchange medium, which may be a solid, liquid, or gas. In some implementations, the Cooling Mechanism 504 may include a Heat Exchanger 505 configured to extract heat from the heat exchange medium. In other implementations, Cooling Mechanism 504 may include conduits in the form of cooling fins on the CESD 200 and the DC-Voltage Conversion Device 400, and the heat exchange medium is air that is blown over the cooling fins, e.g., by a fan. In another implementation, Heat Exchanger 505 may include a phase-change heat pipe configured to carry out cooling. The cooling carried out by the phase-change heat pipe may involve a solid to liquid phase change (e.g., using melting of ice or other solid) or liquid to gas phase change (e.g., by evaporation of water or alcohol) of a phase change material. In yet another implementation, the conduits or Heat Exchanger 505 may include a reservoir containing a solid to liquid phase change material, such as paraffin wax.

As an example and not as a limitation, the Control Board 501 may be based on a controller for a bidirectional buck/boost converter. In such a configuration, the Control Board 501 stabilizes the output voltage of the DC-Voltage Conversion Device 400 according to the following algorithm forming the Control Loop 501A:
a) determining a target output voltage level for the energy storage system,
b) measuring the voltage of a Capacitive Energy Storage Device (CESD) 200,
c) configuring a bidirectional buck/boost converter to buck down the voltage and direct current in the output direction if the voltage on the CESD 200 is higher than the desired output voltage and the desired outcome is to discharge the device,
d) configuring a bidirectional buck/boost converter to boost up the voltage and direct current in the output direction if the voltage on the CESD 200 is lower than the desired output voltage and the desired outcome is to discharge the device,
e) configuring a bidirectional buck/boost converter to buck down the voltage and direct current in the input direction if the voltage on the CESD 200 is lower than the desired input voltage and the desired outcome is to charge the device,
f) configuring a bidirectional buck/boost converter to boost up the voltage and direct current in the input direction if the voltage on the CESD 200 is higher than the desired output voltage and the desired outcome is to charge the device,
g) configuring a bidirectional buck/boost converter to stop outputting power if the voltage on the CESD 200 falls below a predetermined level,
h) configuring a bidirectional buck/boost converter to stop inputting power if the voltage on the CESD 200 exceeds a predetermined level,
i) repeating steps (a) through (f) as necessary.

The specifics of operation of the Control Board 501 are somewhat dependent on the type of buck/boost converter(s) used in the DC-voltage Conversion Device 400. Examples of buck/boost converters and how they are switched to boost/buck the input/output voltages as necessary to achieve the charge and discharge modalities corresponding to voltage labels Vc(t), Vo(t), and Vi(t) in FIG. 5 in this specification are discussed on pages 18 to 21 and depicted in FIGS. 15A and 15B; in FIGS. 9A, 9B, 9C, 9D, 9E, 9F, 9G, 9H, and 9I; and in FIGS. 13A, 13B, 14A, and 14B of a U.S. patent application (Ser. No. 15/043,315), which is mentioned and incorporated by reference in paragraph [0009] of this application. The switch-mode voltage converters may have circuitry selected from the following list: a buck converter, a boost converter, a buck/boost converter, a bi-directional buck/boost (split-pi) converter, a auk converter, a single-ended primary inductor converter (SEPIC), an inverting buck/boost converter, or a four-switch buck/boost converters.

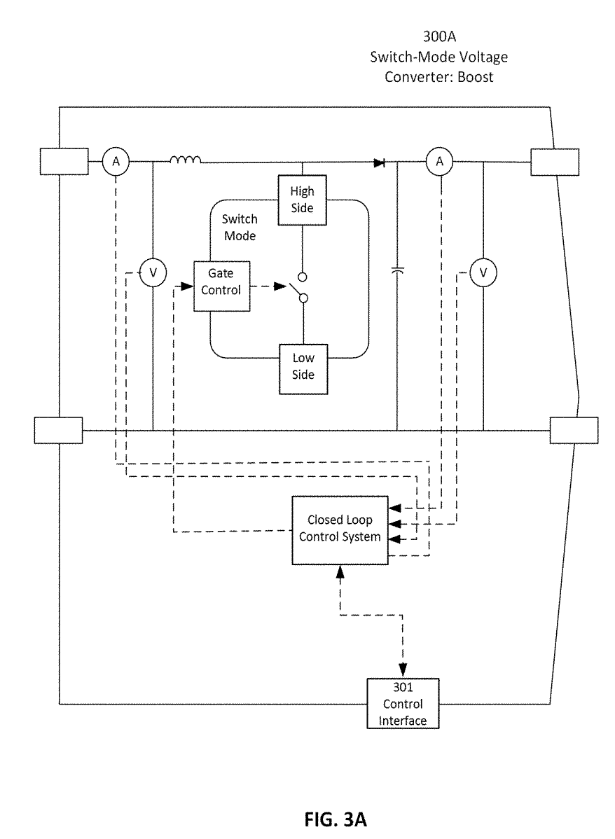

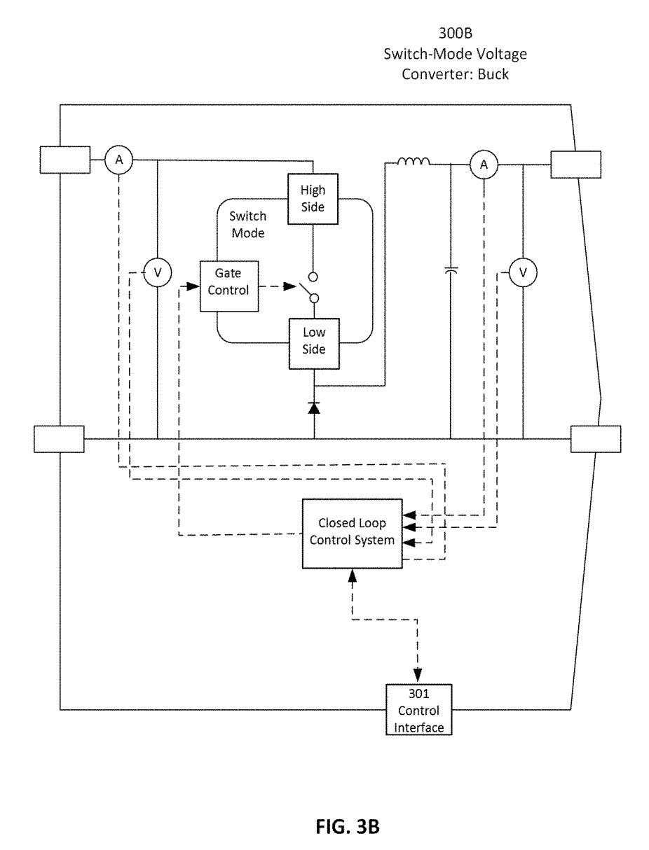

Moreover, in another implementation of CESC 500, the input port, output port, or both ports of the DC-Voltage Conversion Device 400 may be split into separate inputs and outputs. These separate inputs and outputs may have different bus voltages. For example, there may be an input DC bus from a solar inverter which is at a different voltage than an output DC bus meant to transmit power or feed a DC to AC converter. The switch-mode voltage converters, exemplified in FIG. 3A and FIG. 3B, are connected to powers ports, shown as Power Port 404 in FIG. 4 and FIG. 5, by an Interconnect System 403 shown in FIG. 4. The power ports include positive and negative terminals intended to work together to transmit power in either direction. A power port can be an input, an output, or both an input and an output, i.e., bidirectional. A control interface 401 is connected to all of the control interfaces, i.e., Control Interface 301 as shown in FIG. 3A and FIG. 3B, on the switch-mode voltage converters through a Control Network 402. Control Network 402 may carry target voltages, target currents, observed voltages, observed currents, temperatures, and other parameters necessary to control the system. Control Network 402, Control Interface 401, Control Board 501, and Control Loop 501A may or may not be combined in a single discrete physical package. For example, one implementation may have all aforementioned elements distributed throughout a system and another implementation may contain all elements in a single microprocessor unit.

In still another implementation, the CESC 500 includes circuitry configured to enable observation of parameters selected from the following list: the voltage on a meta-capacitor, the current going into or out of a meta-capacitor, the current flowing into or out of the DC-Voltage Conversion Device 400, the output voltage of the DC-Voltage Conversion Device 400, the temperature at one or more points within a meta-capacitor, the temperature at one or more points within the DC-Voltage Conversion Device 400. In another implementation, the CESC 500 further comprises an AC-inverter to create AC output voltage, wherein the DC output voltage of the DC-Voltage Conversion Device 400 is the input voltage of the AC-inverter.

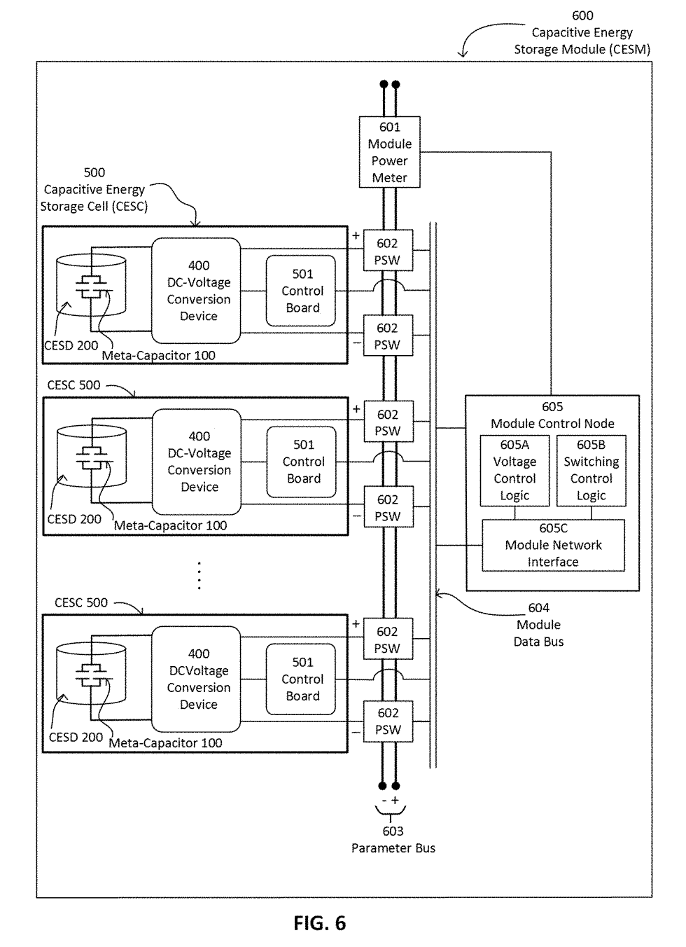

In another aspect of the present disclosure, a CESM 600 is configured by connecting two or more CESC 500 of the type depicted in FIG. 5. One embodiment of such a CESM 600 is shown in FIG. 6. As illustrated in FIG. 6, each CESC 500 includes a CESD 200 having one or more Meta-Capacitors 100 and a DC-Voltage Conversion Device 400, which may be a buck converter, boost converter, or buck/boost converter. Additionally, each CESC 500 may include a Control Board 501 of the type described above as shown in FIG. 5, and an (optional) cooling mechanism (not shown). Moreover, CESM 600 may include an interconnection system that connects the anodes and cathodes of the individual CESC 500 to create a common anode and common cathode of the CESM 600. The interconnection system includes a Parameter Bus 603 and Power Switches (PSW) 602. Each CESC 500 in the CESM 600 may be coupled to the Parameter Bus 603 via the Power Switches (PSW) 602. These switches allow two or more CESM 600s to be selectively coupled in parallel or in series via two or more rails that can serve as the common anode and common cathode. PSW 602 can also allow one or more CESC 500 to be disconnected from the module, e.g., to allow for redundancy or maintenance of the CESC 500s without interrupting operation of the CESM 600. PSW 602 may be based on solid state power switching technology or may be implemented by electromechanical switches (e.g., relays) or some combination of the two.

Additionally, in some implementations, CESM 600 comprises a Module Power Meter 601 to monitor power input or output to the CESM 600. CESM 600 further comprises a Module Control Node 605 configured to control power output from and power input to the CESM 600. The Module Control Node 605 allows each CESM 600 to talk with a system control computer over a high speed network. The Module Control Node 605 includes a Voltage Control Logic 605A circuitry configured to selectively control the operation of each of the DC-Voltage Conversion Device 400 in each of the CESC 500, e.g., via their respective Control Boards 501. The Module Control Node 605 may also include a Switch Control Logic 605B circuitry configured to control operation of the power switches (PSW) 602. The Control Boards 501 and power switches (PSW) 602 may be connected to the Module Control Node 605 via a Module Data Bus 604. The Voltage Control Logic and Switching Control Logic circuitries in the Module Control Node 605 may be implemented by one or more microprocessors, microcontrollers, application specific integrated circuits (ASICs), field programmable gate arrays (FPGAs), or complex programmable logic devices (CPLDs). What is more, the Module Control Node 605 may include a Network Interface 605C to facilitate transfer of signals between the Voltage Control Logic 605A circuitry and the Control Boards 501 on the individual energy storage cells (CESC 500) and also to transfer signals between the Switching Control Logic 605B circuitry and the power switches (PSW) 602, e.g., via the Module Data Bus 604.

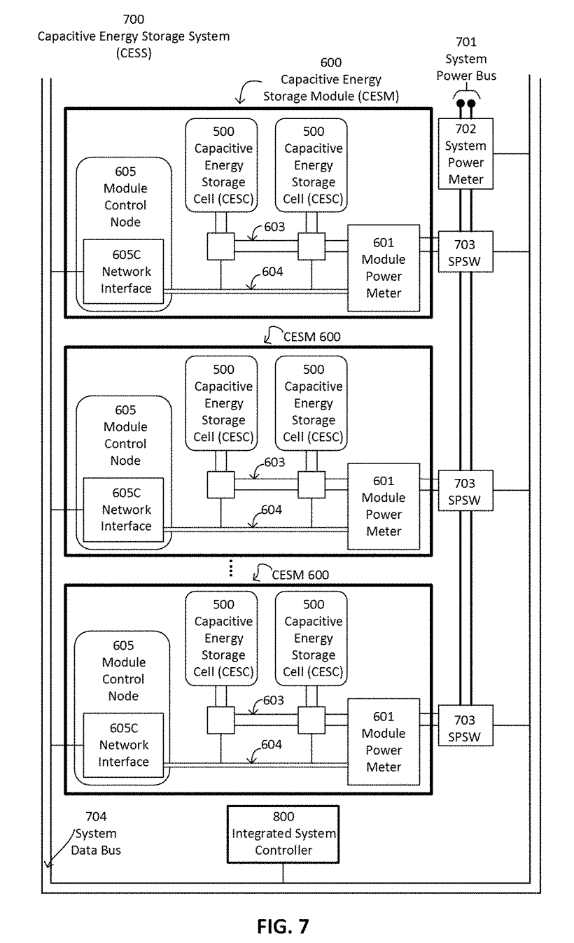

Furthermore, in still another aspect of the present disclosure, a Capacitive Energy Storage System (CESS) 700 is configured by connecting two or more networked Capacitive Energy Storage Modules (CESM) 600 of the type shown in FIG. 6. One embodiment of such a CESS 700 is shown in FIG. 7. Each CESM 600 includes two or more CESC 500, e.g., of the type depicted in FIG. 5, connected by a Parameter Bus 603, i.e., an interconnection system, and controlled by a Module Control Node 605. Each CESM 600 may also include a Module Power Meter 601. Although it is not shown in FIG. 7, each Module Control Node 605 may include Voltage Control Logic 605A circuitry to control voltage converters, i.e., DC-Voltage Conversion Device 400, within the individual CESC 500 and Switching Control Logic 605B circuitry to control internal power switches (PSW 602) within the CESM 600, as described above. In addition, each Module Control Node 605 includes an internal Module Data Bus 604 and a Network Interface 605C, which may be connected as described above. Power to and from CESM 600 is coupled to a System Power Bus 701 via System Power Switches (SPSW) 703, which may be based on solid state power switching technology or may be implemented by electromechanical switches (e.g., relays) or some combination of the two. In some implementations, there may be an inverter (not shown) coupled between each CESM 600 and the System Power Bus 701 to convert DC power from the CESM 600 to AC power or vice versa.

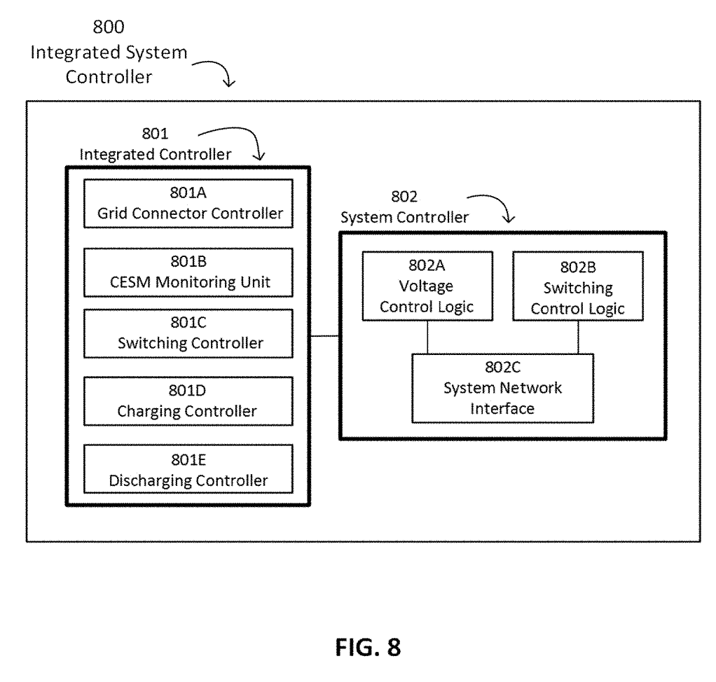

Moreover, as depicted in FIG. 7, CESS 700 comprises an Integrated System Controller 800 connected to a System Data Bus 704. As shown in FIG. 8, Integrated System Controller 800 includes an Integrated Controller 801 and a System Controller 802. Integrated Controller 801 includes a Grid Connector Controller 801A, a CESM Monitoring Unit 801B, a Switching Controller 801C, a Charging Controller 801D, and a Discharging Controller 801E. System Controller 802 consists of a Voltage Control Logic 802A circuitry, a Switching Control Logic 802B circuitry, and a System Network Interface 802C. The Voltage Control Logic 802A circuitry may be configured to control the operation of individual DC-Voltage Conversion Devices 400 within individual CESC 500 of individual CESM 600. The Switching Control Logic 802B circuitry may be configured to control operation not only of the System Power Switches (SPSW) 703 but also of the power switches (PSW) 602 within individual CESM 600. Voltage control signals may be sent from the Voltage Control Logic 802A to a specific DC-Voltage Conversion Device 400 within a specific CESC 500 of a specific CESM 600 through the System Network Interface 802C, the System Data Bus 704, the Module Network Interface 605C of the Module Control Node 605 for the specific CESM 600, the Module Data Bus 604, and the Control Board 501 of the individual CESC 500. In an embodiment, System Controller 802 may be a deterministic controller, an asynchronous controller, or a controller having distributed clock. In one particular embodiment of CESS 700, System Controller 802 may include a distributed clock configured to synchronize several independent DC-Voltage Conversion Devices 400 in one or more CESC 500, shown in FIG. 5, of one or more CESM 600, shown in FIG. 6.

What is more, as shown in FIG. 9, Integrated System Controller 800 is coupled to the Power Conversion Unit (PCU) 904A, the Bi-directional Inverter 904C, and the Grid Connector 904D. Moreover, CESM 600 is coupled not only to the Integrated System Controller 800 but also to the first node N1 of the Power Connection System 904. In an embodiment, the CESS is connected to a computer system with an internet connection or a computer network to enable control of the CBESS such as when buying or selling electricity to the Power Grid 901 based on certain criteria. Examples of such criteria include: the cost of electricity from the PGS 903 compared to the cost of electricity from the Power Grid 901; the cost of electricity from the Power Grid 901 compared to the cost of electricity from a predetermined price; et cetera.

The following paragraphs will now discuss the general functionality of the present invention. The Capacitor Based Energy Storage System (CBESS) 900 is shown in FIG. 9 in block diagram form. The author will discuss each of the blocks in FIG. 9, the interrelationships among the blocks, and the synergy of the blocks as they, as a whole, function as a novel capacitor based energy storage system.

The CBESS 900 can be electrically connected to a Power Generation System (PGS) 903 that generates electric power, a Load 902 that consumes the electric power, and a Power Grid (PG) 901. CBESS 900 may supply the electric power that PGS 903 generated to the Load 902 or the Power Grid 901, or CBESS 900 may store that electric power in its Capacitive Energy Storage System (CESS) 700. Moreover, CBESS 900 may receive electric power from the Power Grid 901 and transfer that electric power to the Load 902, or CBESS 900 may store that received electric power in its CESS 700. Under certain conditions or criteria, which is discussed below, the stored power in CESS 700 may be sold to the Power Grid 901.

The CBESS 900 varies in size depending on space and energy requirements of the Load 902. CBESS 900 may be placed in a cabinet or a box. Additionally, CBESS 900 and the Power Generation System (PGS) 903 may be enclosed within a cabinet or a box if PGS 903 is small enough.

The Power Grid 901 may include power plants, substations, transmission lines, and distribution networks. In the present embodiment, Power Grid 901 supplies power to the CBESS 900 or to the Load 902, or both. Furthermore, Power Grid 901 receives power from CBESS 900 in a normal state of the Power Grid 901. An abnormal state occurs in the Power Grid 901 because of, for example, repair and maintenance of transmission lines and distribution networks, a short-circuit or ground fault accident in any part of Power Grid 901, an electric failure in the power plants or substations, etc. When Power Grid 901 is in an abnormal state, electric power from Power Grid 901 not only to CBESS 900 but also to Load 902 is stopped, and electric power from CBESS 900 to Power Grid 901 is also stopped.

The Load 902 receives power from CBESS 900 or from Power Grid 901. The Load 902 may be residential, commercial, governmental, or industrial buildings; electric and hybrid vehicles; or other consumers of electric power.

The PGS 903 supplies power to the CBESS 900. In some embodiments, PGS 903 comprises a renewable energy source such as from sunlight, water, terrestrial heat, river water current, bio organism, etc. For example, PGS 903 may be a solar power generation system that converts solar energy such as solar heat into electric energy. Furthermore, PGS 903 may be a wind power generation system that converts wind power into electric energy, a terrestrial or ground heat power generation system that converts terrestrial or ground heat into electric energy, a water power generation system, or an ocean power generation system. Additionally, PGS 903 may be a power generation system that uses energy selected from the group consisting of fuel cell, hydrogen, liquefied coal gas, and residual oil gas. PGS 903 may be a combination of the aforementioned power generation systems or other types of power generation systems.

CBESS 900 stores electric power supplied from PGS 903 or from the Power Grid 901, and sells or supplies the stored electric power to the Power Grid 901 or the Load 902. CBESS 900 includes a Power Connection System 904 and a Capacitive Energy Storage System (CESS) 700. The Power Connection System 904 comprises a Power Conversion Unit (PCU) 904A, an optional DC link capacitor 904B, a Bi-directional Inverter 904C, and a Grid Connector 904D. CESS 700 comprises a Capacitive Energy Storage Module (CESM) 600 and an Integrated System Controller 800.

Additionally, FIG. 9 shows that PCU 904A is connected between PUS 903 and a first node N1. PCU 904A converts the electric power that PGS 903 generated into a DC voltage for the first node N1. The operation of PCU 904A varies according to the electric power that PGS 903 generated. For example, if PGS 903 generates an AC voltage, PCU 904A converts the AC voltage into the DC voltage for the first node N1. If PGS 903 generates a DC voltage, PCU 904A converts the DC voltage of PGS 903 to the DC voltage for the first node N1. Various types of converters or rectifiers may be used as the PCU 904A. For example, PCU 904A may be a solar inverter, a maximum power point tracking (MPPT) converter, a DC/DC converter, or an AC/DC converter. If PGS 903 is a solar power generation system, as an example, PCU 904A may be a boost converter such as a MPPT converter that detects an MPP and generates power according to a variation of amount of solar radiation by a solar light or a variation of temperatures by a solar heat.

Furthermore, FIG. 9 shows that the Bi-directional Inverter 904C may be connected between the first node N1 and a second node N2 that is selectively connected to Load 902 or to Grid Connector 904D. The Bi-directional Inverter 904C performs DC-AC inversion, AC-DC conversion, or DC/DC conversion. The Bi-directional inverter 904C converts a DC voltage from PGS 903 through PCU 904A into an AC or DC voltage that is to he supplied to Load 902 or to Grid Connector 904D. Moreover, the Bi-directional Inverter 904C converts an AC or DC voltage output from CESM 600 into an AC or I)C voltage that is to be supplied to Load 902 or to Grid Connector 904D. The Bi-directional Inverter 904C also rectifies an AC voltage output from Grid Connector 904D into a DC voltage for storing in the CESM 600. The Bi-directional Inverter 904C of the present embodiment may be a full bridge inverter and a filter for removing high frequency components. Various other types of bi-directional inverters may be used.

Moreover, FIG. 9 shows that the optional DC Link Capacitor 904B is connected to the first node N1. DC Link Capacitor 904B stabilizes a DC voltage level for the first node N1 as a DC link voltage level. For example, the voltage level for the first node N1 may be otherwise unstable due to a rapid change in the electric power generated by PGS 903 or an instantaneous voltage drop that occurs in the Power Grid 901. However, because of the DC Link Capacitor 904B, the voltage for the first node N1 remains constant in order to perform stable operations of the Bi-directional Inverter 904C and the CESM 600. DC Link Capacitor 90413 may be realized by a super capacitor, and may use an energy storage apparatus such as a capacitive energy storage device. Other types of devices can also be used.

What is more, FIG. 9 shows that the Grid Connector 9041) is connected between Power Grid 901 and Bi-directional Inverter 904C. If an abnormality occurs in Power Grid 901, Grid Connector 904D, under the control of the Integrated System Controller 800, disconnects the CBESS 900 from Power Grid I. Grid Connector 904D) may be realized by a switching element, a bipolar junction transistor (BJT), a field effect transistor (FET), a solid state or relay/contactor, i.e., a magnetic/mechanical relay/contactor, etc.

Although not shown n FIG, 9, an optional switch may additionally be connected between Bi-directional Inverter 904C and Load 902. The optional switch can block power from flowing into Load 902, and Integrated System Controller 800 controls that optional switch. The switch may be realized by a BJT, a FET, etc.

Furthermore, although not shown in FIG. 9, the CESS 700 may interface with a computer network or system, where the computer network or system can be used to determine and compare a cost of electricity from the Power Grid 901 and a cost of electricity from the PGS 903. The Integrated System Controller 800 uses the PGS 903 to charge at least one CESD 200 and to supply electricity to the Load 902, if the cost of electricity from the PGS 903 is less than the cost of electricity from the Power Grid 901. Moreover, the CESS 700 may interface with a computer network or system, where the computer network or system can be used to sell electricity to the Power Grid 901 by having the Integrated System Controller 800 control the discharge of at least one CESD 200 if the cost of electricity from the PGS 903 is less than the cost of electricity from the Power Grid 901.

FIG. 6 illustrates a Capacitive Energy Storage Module (CESM) 600 in an embodiment according to the present invention. CESM 600 includes the plurality of CESC 500, the Module Power Meter 601, the Power Switches 602, the Parameter Bus 603, the Module Data Bus 604, and the Module Control Node 605. Module Control Node 605 consists of the Voltage Control Logic 605A circuitry, the Switching Control Logic 605B circuitry, and the Module Network Interface 605C. CESM 600 may be small, medium, or large depending on energy requirements. In other words, the number of Capacitive Energy Storage Cells (CESC) 500 in the CESM 600 depends on energy requirements.

As illustrated in FIG. 6, CESM 600 includes one or more CESC 500, in which the CESCs are connected in parallel to each other and are individually charged and discharged. And as depicted in FIG. 9, CESM 600 is connected to the first node N1 of the Power Connection System 904, and is charged with electric power supplied from PGS 903 or from Power Grid 901 under the control of the Integrated System Controller 800 in a normal grid state. Furthermore, CESM 600 may supply its stored electric power to the Load 902 or to the Power Grid 901. In an abnormal state of the Power Grid 901, CESM 600 of the present embodiment performs an uninterruptible power supply (UPS) function, transfers the charged power to the Load 902, and simultaneously stores power generated by PGS 903, under the control of the Integrated System Controller 800. In the present embodiment, the plurality of CESC 500 may be individually charged and discharged under the control of the Integrated System Controller 800 in an abnormal grid state. In more detail, some of the CESC 500 may be discharged by supplying the power to the Load 902, while the other CESC 500 may store power generated by PGS 903. Therefore, even though the abnormal grid state continues, CESM 600 can continuously supply a sufficient amount of power to the Load 902.

The CESC 500 may include one or more meta-capacitors, e.g., as described in the U.S. patent application (Ser. No. 15/043,315) to Ian Kelly Morgan et al, filed 12 Feb. 2016, which may include a meta-dielectric material between two electrodes. This patent application is mentioned and incorporated by reference in paragraph [0009] herein. Examples of such meta-dielectric material are described above and in the following applications: U.S. patent application (Ser. No. 15/043,247) to Barry K. Sharp et al, filed 12 Feb. 2016 and U.S. patent applications (Ser. Nos. 15/043,186 and 15/043,209) to Paul Furuta et al, filed 12 Feb. 2016, in which the entirety of the disclosures of these applications are incorporated herein by reference.

The plurality of CESC 500 store not only power generated by the PGS 903, but also power supplied from the Power Grid 901, under the control of the Integrated System Controller 800 in a normal grid state. When the plurality of CESC 500 are disconnected from the Power Grid 901 in an abnormal state, some of the CESC 500 are charged with power supplied from PGS 903 under the control of the Integrated System Controller 800. The other CESC 500 are discharged to supply power to the Load 902 under the control of the Integrated System Controller 800 as well.

FIG. 8 is a block diagram of the Integrated System Controller 800 in an embodiment according to an aspect of the present disclosure. Integrated System Controller 800 includes Integrated Controller 801 and System Controller 802. Integrated System Controller 800 controls the various components or blocks of the CBESS as discussed above. The Grid Connector Controller 801A detects a normal state or an abnormal state of the Power Grid 901, and controls the Grid Connector 904D in order to disconnect the Power Grid 901 in the abnormal state. The System Controller 802 enables the Integrated Controller 801 to control the CESM 600, the Power Conversion Unit (PCU) 904A, the DC Link Capacitor 904B, the Bi-directional Inverter 904C, and the Grid Connector 904D so as to store the power generated by the PGS 903 in the CESM 600 even in the abnormal grid state. Furthermore, System Controller 802 enables the Integrated Controller 801 to control the CESM 600, the Bi-directional Inverter 904C, et cetera so as to supply the power stored in the CESM 600 to the Load 902 in the abnormal grid state such that the CBESS may perform an uninterruptible power supply function.

Referring to FIG. 8, the Integrated Controller 801 includes the following: (1) a Grid Connector Controller 801A that detects an abnormal state of the Power Grid 901 and disconnects the Power Grid 901 from the CBESS 900; (2) a CESM Monitoring Unit 801B; (3) a Switching Controller 801C; (4) a Charging Controller 801D that the DC-Voltage Conversion Device 400 and the System Controller 802 enable to regulate the charging of the CESC 500; and (5) a Discharging Controller 801E that the DC-Voltage Conversion Device 400 and the System Controller 802 enable to regulate the discharging of the CESC 500. In addition to detecting the normal or abnormal state of the Power Grid 901, the Grid Connector Controller 801A detects other conditions, parameters, or states of the Power Grid 901 such as voltage, current, temperature, AC phase, et cetera.

The CESM Monitoring Unit 801B monitors the charging and discharging states of each of the CESC 500 in the CESM 600, and determines which of the individual CESC 500 to charge or discharge. However, the CESM Monitoring Unit 801B is not limited to such monitoring. For example, the CESM Monitoring Unit 801B may further monitor the remaining power capacity, voltage, and current through the System Controller 802. The CESM Monitoring Unit 801B determines whether to charge the CESCs that are in an incomplete charging state when the power grid is in the abnormal state. Moreover, the CESM Monitoring Unit 801B determines whether to discharge the CESCs that are in a complete charging state. In this regard, the complete charging state may mean a state where the remaining power capacity of an individual CESC 500 exceeds a reference level. The incomplete charging state may mean a state where the remaining power capacity of an individual CESC 500 is less than the reference level or less than another reference level. However, aspects of the present disclosure are not limited thereto, and the complete charging state may mean a full charging state of the CESC 500 or a state where the CESC 500 can stably supply power to the Load 902 for a period of time. The incomplete charging state may mean a state where the CESC 500 reaches a minimum charging value or a state where the CESC 500 cannot stably supply power to the Load 902 for a period of time.

The Switching Controller 801C communicates with the System Controller 802, the Module Control Node 605 in a particular CESM 600, the Control Board 501 in a particular CESC 500, and the DC-Voltage Conversion Device 400 for that particular CESC 500 to charge or discharge certain capacitive energy storage device(s), according to the determination of the CESM Monitoring Unit 801B.

The Charging Controller 801D controls the Power Conversion Unit (PCU) 904A to convert the power that the Power Generation System (PGS) 903 generated to a DC voltage for the first node N1. Furthermore, Charging Controller 801D is enabled by the System Controller 802 to charge each individual CESC 500 to store power generated by the PGS 903 in that CESC 500 within a particular CESM 600.

The Discharging Controller 801E controls the Bi-directional Inverter 904C to invert the DC voltage for the first node N1 into an AC voltage and to supply the AC voltage to the Load 902. Moreover, Discharging Controller 801E is enabled by the System Controller 802 to discharge each individual CESC 500 to supply the electric power stored in that CESC 500, within a particular CESM 600, to the Load 902 or the Power Grid 901.

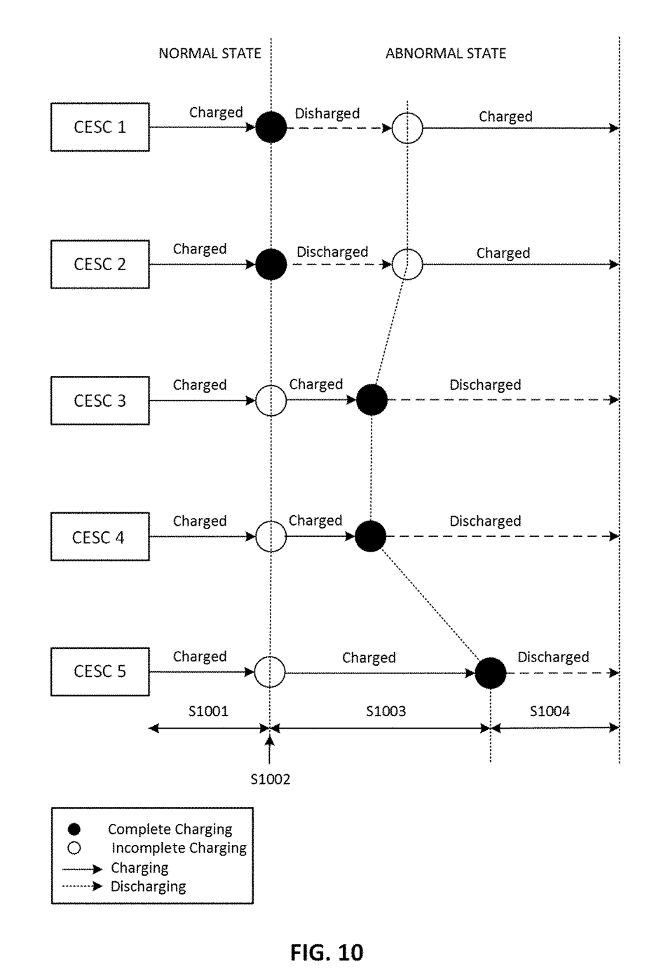

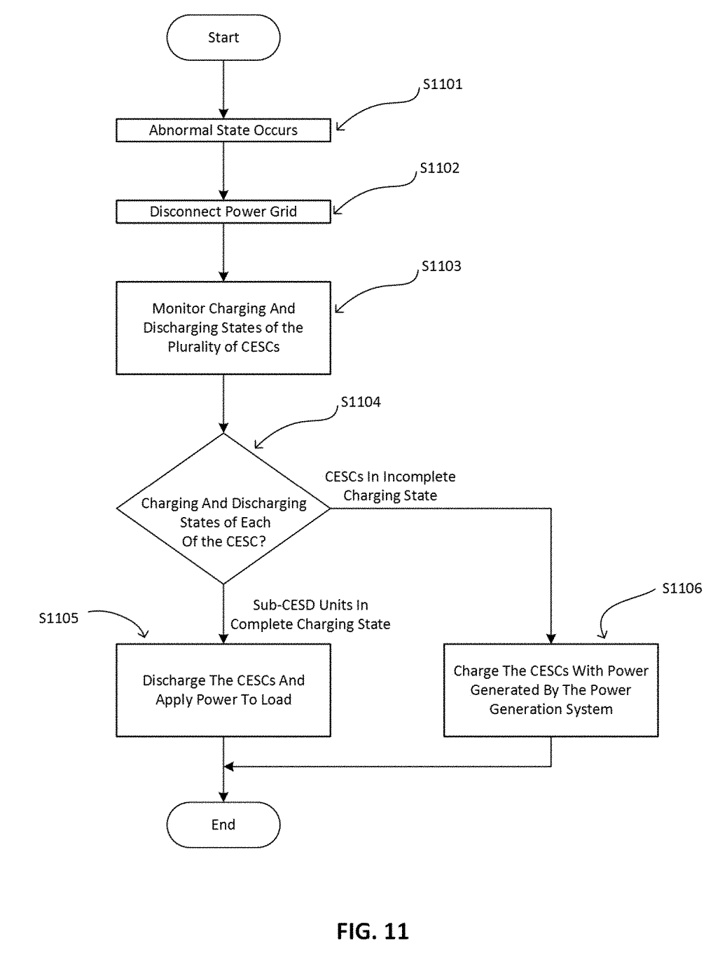

The operation of the Integrated System Controller 800 is described with reference to FIG. 10 and FIG. 11. FIG. 10 is a state diagram illustrating the operation of the Integrated System Controller 800 according to an aspect of the present disclosure. Referring to FIG. 10, the Capacitive Energy Storage Module (CESM) 600 of this embodiment includes five Capacitive Energy Storage Cells (CESC) 500. However, the number and structure of the CESCs are not limited thereto. CESM 600 is charged with electric power from the Power Generation System (PGS) 903 or from the Power Grid 901 in a normal grid state, labelled as “S1001” in FIG. 10. Some of the CESC 500 may be in a complete charging state. The other CESC 500 may be in an incomplete charging state. The complete charging state or the incomplete charging state may depend on a type and capacity of the CESM 600 and on a type of Load 902, or may be determined according to charging and discharging states of each of the CESC 500.

When an abnormal state occurs in the Power Grid 901, with the abnormal state labelled as “S1002” in FIG. 10, the Integrated System Controller 800 disconnects the Power Grid 901 from the Capacitor Based Energy Storage System (CBESS) 900 using Grid Connector 904D. The Integrated System Controller 800 controls the CBESS to supply electric power stored in the CESM 600 to the Load 902 or to supply electric power that the PGS 903 generated to the load 902, in order for the CBESS 900 to function as an uninterruptible power supply (UPS).

If the abnormal power grid state starts, the Integrated System Controller 800 monitors states of the CESC 500 and the PGS 903. For example, referring to FIG. 10, suppose that CESC 1 and CESC 2 are in a complete charging state, and CESC 3, CESC 4, and CESC 5 are in an incomplete charging state. The Integrated System Controller 800 communicates not only with the Module Control Node 605 of the CESM 600 consisting CESC 1 and CESC 2 but also with the Control Board 501 of CESC 1 and CESC 2, and makes the DC-Voltage Conversion Device 400 of CESC 1 and CESC 2—using the devices' switch-mode voltage converters—to boost up or buck down the voltage and direct current in the output direction, depending on whether the voltage on the CESD of CESC 1 and CESC 2 is higher or lower compared to a desired output voltage, such that CESC 1 and CESC 2 are discharged to supply power to the Load 902. Furthermore, the Integrated System Controller 800 communicates not only with the Module Control Node 605 of the CESM 600 consisting CESC 3, CESC 4, and CESC 5 but also with the Control Board 501 of CESC 3, CESC 4, and CESC 5, and makes the DC-Voltage Conversion Device 400 of CESC 3, CESC 4, and CESC 5—using the devices' switch-mode voltage converters—to boost up or buck down the voltage and direct current in the input direction, depending on whether the voltage on the CESD of CESC 3, CESC 4, and CESD 5 is higher or lower compared to a desired input voltage, such that CESC 3, CESC 4, and CESC 5 are charged with power supplied from the PGS 903. The label “S1003” in FIG. 10 covers the states where CESC 1 and CESC 2 are discharged and the states where CESC 3, CESC 4, and CESC 5 are charged in the abnormal power grid state.

While the abnormal power grid state continues, the Integrated System Controller 800 periodically monitors the CESM 600 and the PGS 903. If CESC 1 or CESC 2 is in the incomplete charging state, the Integrated System Controller 800 communicates not only with the Module Control Node 605 of the CESM 600 consisting CESC 1 and CESC 2 but also with the Control Board 501 for CESC 1 and CESC 2, and makes the DC-Voltage Conversion Device 400 of CESC 1 and CESC 2—using the devices' switch-mode voltage converters—to boost up or buck down the voltage and direct current in the input direction, depending on whether the voltage on the CESD of CESC 1 or CESC 2 is higher or lower compared to a desired input voltage, such that CESC 1 or CESC 2 is charged with power supplied from the PGS 903. If at least one of CESC 3, CESC 4, and CESC 5 is in the completely charged state, the Integrated Controller 200 communicates not only with the Module Control Node 605 of the CESM 600 consisting CESC 3, CESC 4, and CESC 5 but also with the Control Board 501 of CESC 3, CESC 4, and CESC 5, and makes the DC-Voltage Conversion Device 400 of CESC 3, CESC 4, and CESC 5—using the devices' switch-mode voltage converters—to boost up or buck down the voltage and direct current in the output direction, depending on whether the voltage on the CESD of CESC 3, CESC 4, or CESC 5 is higher or lower compared to a desired output voltage, such that CESC 3, CESC 4, or CESC 5 is discharged to supply power to the Load 902. The label “S1004” in FIG. 10 covers the states where CESC 1 and CESC 2 are charged and the states where CESC 3, CESC 4, or CESC 5 are discharged in the abnormal power grid state.

The process shown in FIG. 10 is merely an example, the present invention is not limited thereto, and various processes may be performed. For example, an abnormal power grid state may occur when all five CESCs are in the completely charged state. The CESM Monitoring Unit 801B may monitor the charging state of the CESCs, and the Switching Controller 801C may communicate with the System Controller 802, the Module Control Node 605 in a particular CESM 600, the Control Boards 501 of all five CESCs, and the DC-Voltage Conversion Devices 400 for all five CESCs to discharge all five CESCs.

FIG. 11 is a flowchart illustrating a method of operating the Capacitor Based Energy Storage System (CBESS) 900, according to an embodiment of the present invention. Referring to FIG. 11, when an abnormal state occurs in the Power Grid 901 (S1101) due to, for example, repair and management of distribution lines, a short-circuit accident, a ground fault accident, or an electric failure, the Integrated System Controller 800 of CBESS 900 detects the abnormal state and disconnects the Load 902 and the Bi-directional Inverter 904C from the Power Grid 901 (S1102). The Integrated System Controller 800 monitors the charging and discharging states of each of the CESC 500 (S1103). The Integrated System Controller 800 determines the CESC 500 that is in a complete charging state (S1104), communicates not only with the Module Control Node 605 of the CESM 600 consisting that CESC 500 but also with the Control Board 501 for that CESC 500, and makes the DC-Voltage Conversion Device 400—using its switch-mode voltage converter(s)—for that CESC 500 to boost up or buck down the voltage and direct current in the output direction, depending on whether the voltage on the CESD 200 is higher or lower compared to a desired output voltage, such that the particular CESC 500 is discharged to supply power to the Load 902 (S1105). Furthermore, the Integrated System Controller 800 determines the CESC 500 that is in an incomplete charging state (S1104), communicates not only with the Module Control Node 605 of the CESM 600 consisting that CESC 500 but also with the Control Board 501 for that CESC 500, and makes the DC-Voltage Conversion Device 400—using its switch-mode voltage converter(s)—for that CESC 500 to boost up or buck down the voltage and direct current in the input direction, depending on whether the voltage on the CESD 200 is higher or lower compared to a desired input voltage, such that the particular CESC 500 is charged with power generated by the PGS 903 (S1106). If the abnormal grid state continues, the Integrated System Controller 800 may monitor charging and discharging states of the CESCs in real time and individually control the monitored charging and discharging states of the CESCs as described with reference to FIG. 10.

Additionally, although not shown in the flowchart of FIG. 11, where a method of operating a CBESS 900 is illustrated, the method may include interfacing the CESS 700 with a computer network or system. The method uses the computer network or system to determine and compare a cost of electricity from the Power Grid 901 and a cost of electricity from the PGS 903; uses PGS 903 to charge at least one CESD 200 and to supply electricity to the Load 902, if the cost of electricity from the PGS 903 is less than the cost of electricity from the Power Grid 901; sells electricity to the Power Grid 901 by discharging at least one CESD 200 if the cost of electricity from the PGS 903 is less than the cost of electricity from the Power Grid 901; and buys electricity from the Power Grid 901 to charge at least one CESD 200 when there is deficient capacity in at least one CESD 200 and the cost of electricity from the Power Grid 901 is below a predetermined price.

The above description shows that the invention disclosed provides a novel and advantageous capacitor based energy storage system using meta-capacitors. The foregoing discussion is presented to enable one of ordinary skill in the art to make and use the invention and to incorporate it in the context of particular applications. Various modifications, as well as a variety of uses in different applications will be apparent to those skilled in the art, and the general principles defined herein may be applied to a wide range of embodiments. Thus, the present invention is not intended as limited to the embodiments presented. Instead, the invention should be accorded the widest scope consistent with the principles and novel features disclosed herein.

Furthermore, any element in a claim that does not explicitly state “means for” performing a specified function, or “step for” performing a specific function, is not to be interpreted as a “means” or “step” clause as specified in 35 U.S.C. Section 112, Paragraph 6.

While the above discussion is a full description of the specific embodiments, various modifications, alternative constructions and equivalents may be used. Thus, the above description and illustrations should not be taken as limiting the scope of the present invention which is defined by the following claims.

What is claimed is:

1. A capacitor based energy storage system, comprising:
a capacitive energy storage system (CESS) including a plurality of capacitive energy storage module (CESM) and an integrated system controller coupled to the plurality of CESM, wherein each CESM includes a plurality of capacitive energy storage cell (CESC) configured to be charged with power from a power generation system or a power grid and to be discharged to supply power to a load or the power grid, wherein each CESC includes one or more capacitive energy storage devices (CESD), each of which is coupled to a corresponding DC-voltage conversion device, wherein each CESC includes a control board to stabilize an output voltage of the DC-conversion device and to control a charging and a discharging of each of the one or more CESD, wherein each of the one or more CESD includes at least one meta-capacitor, wherein an output voltage of the CESD is an input voltage of the DC-voltage conversion device during discharging the CESD, and wherein an input voltage of the CESD is the output voltage of the DC-voltage conversion device while charging the CESD; and
a power connection system coupled to the integrated system controller, in which the power connection system includes an power conversion unit, a bi-directional inverter, an optional DC link capacitor, and a grid connector, wherein the power conversion unit is connected between the power generation system and a first node and configured to convert power generated by the power generation system into a DC voltage for the first node, wherein the bi-directional inverter is connected between the first node and a second node and configured to convert the DC voltage for the first node into an AC voltage for the load or the power grid and to convert an AC voltage from the power grid into the DC voltage for the first node, wherein the optional DC link capacitor is connected to the first node, and wherein the grid connector is connected between the power grid and the second node.

2. The capacitor based energy storage system of claim 1, wherein the integrated system controller is coupled to the power conversion unit, the bi-directional inverter, and the grid connector, wherein the integrated system controller is configured to determine a state of the power grid, and wherein, if the power grid is in an abnormal state, the integrated system controller monitors a charging status and a discharging status of each CESD, controls each CESD to supply power to the load, and charges each CESD or simultaneously charges the plurality of CESD with power generated by the power generation system.

3. The capacitor based energy storage system of claim 1, wherein, if the power grid is in the abnormal state, the integrated system controller supplies the load with power generated by the power generation system.

4. The capacitor based energy storage system of claim 1, wherein the power generation system comprises a renewable energy source.

5. The capacitor based energy storage system of claim 1, wherein the power generation system is a solar power generation system, a wind power generation system, a ground heat power generation system, a water power generation system, an ocean power generation system, or a power generation system that uses energy selected from the group consisting of fuel cell, hydrogen, liquefied coal gas, and residual oil gas.

6. The capacitor based energy storage system of claim 1, wherein, if the power grid is in the abnormal state, the at least one CESD that is charged below a minimum level, as determined by the control board and the integrated system controller, can be charged with power supplied from the power generation system, and the at least one CESD that is charged above a minimum level, as determined by the control board and the integrated system controller, can be discharged by supplying power to the load.

7. The capacitor based energy storage system of claim 1, wherein the integrated system controller comprises:
a power grid controller configured to detect the abnormal state of the power grid, to control the grid connector, and to disconnect the power grid from the second node;
a charging controller configured to control the power conversion unit so as to charge the CESDs with power generated by the power generation system;
a discharging controller configured to control the bi-directional inverter so as to supply power stored in the CESDs to the load or the power grid;
a switching control logic configured to control operation of a plurality of system power switches (SPSW) within the CESS and a plurality of power switches (PSW) within an individual capacitive energy storage module;
a voltage control logic configured to send voltage control signals to a specific DC-voltage conversion device within a specific capacitive energy storage cell of a specific capacitive energy storage module; and
a network interface coupled to the switching control logic, the voltage control logic, a system data bus, a system power meter, and the plurality of system power switches.

8. The capacitor based energy storage system of claim 1, wherein the power conversion unit is a solar inverter, a maximum power point tracking (MPPT) converter, a DC/DC converter, or an AC/DC converter.

9. The capacitor based energy storage system of claim 1, wherein the capacitive energy storage system (CESS) interfaces with a computer network or a computer system;
the computer network or the computer system operable to determine a cost of electricity from the power grid and a cost of electricity from the power generation system;
the CESS operable to charge the at least one CESD and to supply electricity to the load, with power from the power generation system, if the cost of electricity from the power generation system is less than the cost of electricity from the power grid or from a predetermined price;
the CESS operable to sell electricity to the power grid by discharging the at least one CESD if the cost of electricity from the power generation system is less than the cost of electricity from the power grid; and
the CESS operable to buy electricity from the power grid to charge the at least one CESD if the cost of electricity from the grid is less than a predetermined price.

10. The capacitor based energy storage system of claim 1, wherein the meta-capacitor includes a first electrode, a second electrode, and a metadielectric material layer disposed between the first electrode and the second electrode.

11. The capacitor based energy storage system of claim 10, wherein the first electrode, the second electrode, and the metadielectric material layer are in a form of long strips of material that are sandwiched together and wound into a coil along with an insulating material to prevent electrical shorting between the first electrode and the second electrode.

12. The capacitor based energy storage system of claim 10, wherein the metadielectric material layer is comprised of structured polymeric materials (SPM) having a relative permittivity greater than or equal to 1000, a resistivity greater than or equal to 10¹⁵ Ohms·cm, and a breakdown field greater than or equal to 0.01 volts/nanometer.

13. The capacitor based energy storage system of claim 10, wherein the metadielectric material layer is comprised of one or more composite organic compounds characterized by polarizability and resistivity.

14. The capacitor based energy storage system of claim 10, wherein the metadielectric material layer is comprised of composite organic compounds forming supra-structures.

15. A capacitor based energy storage system according to claim 10, wherein the metadielectric material layer is comprised of a Sharp polymer having a core that is an aromatic polycyclic conjugated molecule and wherein the molecule has flat anisometric form and self-assembles by pi-pi stacking in a column-like supramolecule.

16. A capacitor based energy storage system according to claim 10, wherein the metadielectric material layer is comprised of polymeric chains tethered polarization substituents and electrically resistive side chains that enable structured polymer films.

17. The capacitor based energy storage system of claim 10, wherein the metadielectric material layer is comprised of composite organic compounds forming supra-structures that are crystalline in at least 1 dimension.

18. The capacitor based energy storage system of claim 17, wherein the meta-dielectric material layer is selected from the group consisting of Sharp polymers, Furuta co-polymers, para-Furuta polymers, and Furuta polymers.

19. A method of operating a capacitor based energy storage system connected to a power generation system, a power grid, and a load, the capacitor based energy storage system including a capacitive energy storage system (CESS) containing a plurality of capacitive energy storage module (CESM) coupled to an integrated system controller and a power connection system coupled to the integrated system controller, wherein each CESM includes a plurality of capacitive energy storage cell (CESC) configured to be charged with power from the power generation system or the power grid and to be discharged to supply power to the load or the power grid; wherein each CESC includes one or more capacitive energy storage devices (CESD), each of which is coupled to a corresponding DC-voltage conversion device; wherein the at least one CESD includes at least one meta-capacitor; wherein the power connection system contains an optional power conversion unit, a bi-directional inverter, an optional DC link capacitor, and a grid connector; wherein the power conversion unit is connected between the power generation system and a first node and configured to convert power generated by the power generation system into a DC voltage for the first node; wherein the bi-directional inverter is connected between the first node and a second node and configured to convert the DC voltage for the first node into an AC voltage for the load or the power grid and to convert an AC voltage from the power grid into the DC voltage for the first node; wherein the optional DC link capacitor is connected to the first node; and wherein the grid connector is connected between the power grid and the second node, the method comprising:
disconnecting the power grid from the capacitor based energy storage system as a result of the power grid being in an abnormal state;
monitoring a charging status and a discharging status of each of the one or more CESD; and
according to the charging status and the discharging status of each of the CESD, discharging the one or more CESD to supply power to the load and simultaneously charging the one or more CESD with power generated by the power generation system.

20. The method of claim 19, wherein the capacitive energy storage system (CESS) interfaces with a network and a computer system with an Internet connection, the method further comprising:
using the network and the computer system to determine a cost of electricity from the power grid and a cost of electricity from the power generation system;
using the power generation system to charge the one or more CESD and to supply electricity to the load, if the cost of electricity from the power generation system is less than the cost of electricity from the power grid;
selling electricity to the power grid by discharging the one or more CESD if the cost of electricity from the power generation system is less than the cost of electricity from the power grid; and
buying electricity from the power grid to charge the one or more CESD when there is deficient capacity in the one or more CESD and the cost of electricity from the power grid is below a predetermined price.
